(19) United States
(12) Patent Application Publication
(10) Pub. No.: US 2005/0051667 A1
(43) Pub. Date: Mar. 10, 2005

(54) Micro-rotorcraft surveillance system

(76) Inventors: Paul E. Arlton, West Lafayette, IN (US); David J. Arlton, West Lafayette, IN (US)

Correspondence Address: BARNES & THORNBURG, 11 SOUTH MERIDIAN, INDIANAPOLIS, IN, 46204, US

(21) Appl. No.: 10/499,530

(22) PCT Filed: Dec. 19, 2002
(86) PCT No.: PCT/US02/41280

Related U.S. Application Data
(60) Provisional application No. 60/342,680, filed on Dec. 21, 2001.
(60) Provisional application No. 60/372,308, filed on Apr. 12, 2002.

(51) Int. Cl. B64C 27/00

(52) U.S. Cl. 244/17.11

(57) ABSTRACT

A flying micro-rotorcraft unit (18, 24, 310, 330, 370) is provided for remote tactical and operational missions. The unit (18, 24, 310, 330, 370) includes an elongated body (52) having an upper and a lower end. The body (52) defines a vertical axis (60). The unit (18, 24, 310, 330, 370) further includes a navigation module (54) including means for determining a global position of the elongated body (52) during flight of the unit (18, 24, 310, 330, 370). Rotor means of the unit (18, 24, 310, 330, 370) is coupled to the upper end of the elongated body (52) for generating a thrust force that acts in a direction parallel to the vertical axis (60) to lift the elongated body (52) into the air. The rotor means is located between the elongated body (52) and the navigation module (54).

### CROSS-REFERENCE TO RELATED APPLICATIONS

This application claims priority under 35 U.S.C. § 119(e) to U.S. Provisional Patent Application Ser. Nos. 60/342,680, filed Dec. 21, 2001 and 60/372,308, filed Apr. 12, 2002, the disclosure of each of which is hereby incorporated by reference herein.

### BACKGROUND

The present disclosure relates to unmanned aerial devices. Particularly, the present disclosure relates to hand-held, remotely operated devices for tactical operations.

Modem warfare and law enforcement are increasingly characterized by extensive guerilla and counter-terrorism operations conducted by small tactical units of paramilitary personnel. These units are tasked to root out and defend against hostile forces and/or criminal elements that threaten the unit or the public. Unfriendly forces frequently hide themselves from view or exploit the local terrain to gain tactical advantage or escape from pursuers. In the presence of hostile forces, a simple brick wall, barbed wire fence, body of water, high building or even a large open area devoid of cover can be an insurmountable obstacle when time is of the essence and tactical resources (such as, for instance, a ladder, boat or aircraft) are unavailable. An active threat (such as hostile forces or an armed suspect) can make the situation deadly.

Stealth and surprise are important elements of tactical advantage; especially where the position and composition of opposing forces is unknown. Visible indications, loud noises, and predictable actions can reveal friendly forces and expose them to hostile fire and casualties. Tactical forces need an unobtrusive, real-time way to visualize their surroundings and objective, reconnoiter the terrain, detect hostile forces and project force at a distance.

Ballistic methods of surveillance, wherein a projectile or other device is brought to an altitude to descend passively (sometimes with a parachute or other aerodynamic means of control), may have limitations. Ballistic devices generally have limited time aloft, cannot rise and descend repeatedly under their own power and cannot maintain prolonged horizontal flight. This may act to limit their radius of effectiveness and tactic usefulness.

In this age of technology, warfare and law enforcement are increasingly automated and computerized through the use of drones—robotic vehicles that allow their operators to perform tasks and gather information from a distance without exposing themselves to potentially dangerous situations. Current drones, however, have many practical limitations. Some, such as wheeled vehicles, are restricted to use over smooth, solid surface. Others, such as remotely controlled airplanes must operate at relatively high altitudes to avoid crashing into the local terrain, and require special means of deployment and recovery such as long runways, for example. Most available drones also suffer from lack of portability, and significant support equipment is required for their proper operation.

Robotic rotorcraft, such as radio controlled helicopters, are typically complex, expensive and may be prone to severe damage. In the normal course of operation and maneuvering, the rotor blades of traditional helicopters can come into contact with a body portion of the helicopter or the local terrain which can often leading to the destruction and operational loss of the helicopter. Due to their size and configuration, available robotic rotorcraft may also be relatively cumbersome to operate, transport and store.

What is needed is a robotic system that can extend the situational awareness of tactical forces and enhance their ability to deploy sensors and deliver ordnance with high accuracy. Ideally, the system should be simple, compact and expendable to allow for losses in the field. A light weight, portable system would be highly desirable.

### SUMMARY

The present disclosure comprises one or more of the following features discussed below, or combinations thereof:

A hand-held, miniature flying micro-rotorcraft unit provides remote surveillance, tactical, operational and communication capabilities. The hand-held micro-rotorcraft unit is capable of being deployed anywhere to fly remotely and navigate through various obstacles and over various terrain. The hand-held unit includes a small, elongated body defining a vertical axis. The elongated body includes a plurality of interchangeable, modular components including a power module, a drive module, a payload module, and a navigation module. Extendable/retractable elements are provided to couple to the elongated body, and to be extended during flight to perform various operational functions.

A rotor means is coupled to an upper end of the hand-held elongated body for rotation about the vertical body axis to lift the hand-held elongated body into the air. The rotor means is driven by drive means located within the drive module. The rotor means may include a pair of upper rotor blades coupled to a first rotatable hub, a pair of lower rotor blades coupled to a second rotatable hub, and means for supporting the first and second rotatable hubs for rotation about the vertical body axis in opposite directions.

The power module includes a power supply for energizing the drive means. The navigation module includes means for determining a global position of the hand-held elongated body during flight of the micro-rotorcraft unit. The payload module may include explosive or incendiary munitions, and biological or chemical sensors, for example.

Features of the present disclosure will become apparent to those skilled in the art upon consideration of the following detailed description of illustrative embodiments exemplifying the best mode of carrying out the disclosure as presently perceived.

### BRIEF DESCRIPTION OF THE DRAWINGS

The detailed description particularly refers to the accompany figures in which:

FIG. 1 is a diagrammatic view of an integrated micro-rotorcraft system of the present disclosure for providing remote surveillance of an area showing a mobile command center of the system and various micro-rotorcraft units of the system which are in communication with the mobile command center;

FIG. 2 is a side view of the illustrative mobile command center of the system showing an all-terrain vehicle of the command center, an operator and computer network within the mobile command center, and a trailer for hauling micro-rotorcraft units therewith;

FIG. 3a is a perspective view of the trailer shown in FIG. 2 showing four mobile base units carried on the trailer, and further showing each mobile base unit including multiple storage cavities or tubes for stowing various micro-rotorcraft units therein;

FIG. 3b is a rear view of the trailer of FIG. 3a;

FIG. 3c is a side view of the trailer of FIGS. 3a and 3b;

FIG. 4 is a perspective view of a hand-held surveillance micro-rotorcraft unit showing the unit including a co-axial, counter-rotating rotor system and an elongated body having interchangeable modular components coupled to the rotor mechanism;

FIG. 5 is an exploded perspective view of the micro-rotorcraft unit shown in FIG. 4 showing a first module or component of the body coupled to the rotor system and including a motor, a second, or middle, module including a battery pack, and a third, or end, module for carrying a payload;

FIG. 6 is a perspective view of a modular coupling attachment mechanism of the unit shown in FIGS. 4 and 5 showing an end of each modular component having a toothed coupling ring of the coupling mechanism;

FIG. 7 is a side elevation view of the rotorcraft unit of FIGS. 4-6 showing a spring-loaded rotor blade element retained in a storage configuration, and also showing the element extendable toward a flight configuration and having a nominal flapping angle when in the flight configuration;

FIG. 8 is a perspective view of the unit of FIGS. 4-7 showing the flexible rotor blades of the rotor system being bent by the hand of an operator to illustrate the durability of the rotor blade;

FIG. 9 is a perspective view of the unit of FIGS. 4-8 showing the unit in the stowed position for storage into a storage tube or carrying case of the present disclosure;

FIG. 10 is a top view of the unit and carrying case showing the unit stowed within the case for transport by an operator,

FIGS. 11a-11c shows first, second and third steps in manually deploying the unit;

FIG. 12 is a perspective view showing a method of deploying the rotorcraft unit of FIGS. 4-10 from an aircraft in flight;

FIGS. 13a-13c are perspective views of the rotorcraft unit of FIGS. 4-10 showing first, second and third steps in landing or recovering the unit;

FIG. 14 is a perspective view of another micro-rotorcraft unit for use with the integrated system of the present disclosure showing the micro-rotorcraft unit including an outer wire cage, a central body coupled to the cage, and rotor blades coupled to the body;

FIG. 15 is a side view of the micro-rotorcraft unit shown in FIG. 7;

FIG. 16 is a top view of the micro-rotorcraft unit shown in FIGS. 7 and 8;

FIG. 17 is a perspective view of yet another micro-rotorcraft unit for use with the integrated system of the present disclosure showing the micro-rotorcraft unit including a body, a rotor system with rotor blades attached to the body, and a tail having a rudder and another set of rotor blades attached thereto;

FIG. 18 is a perspective view of still another micro-rotorcraft unit for use with the integrated system of the present disclosure showing the unit including an elongated body, a rotor system coupled to the body at an upper end, and a landing gear system, shown in a landing configuration, coupled to the body at a lower end of the body to allow the unit to stand upright as shown;

FIG. 19 is a perspective view of the micro-rotorcraft unit of FIG. 18 showing the landing gear system and the rotor blades of the rotor system in a stowed or retracted position;

FIG. 20 is a perspective view of another rotorcraft unit of the present disclosure showing the unit having a co-axial counter-rotating rotor system with rotor blade elements appended to an upper end of an elongated body portion, aerodynamic fin elements appended to a lower end of the body, and the rotor blade elements and fin elements being shown extended in a flight configuration;

FIG. 21 is a perspective view of another rotorcraft unit of the present disclosure showing the unit having a single rotor system with rotor blade elements appended to an upper end of the elongated body, and also disclosing mechanically driven, variable-thrust yaw control elements appended to a mid-section of the body, and showing the yaw control elements extended in a flight configuration;

FIG. 22 is a perspective view of the unit shown in FIG. 21 (with portions broken away) showing the yaw elements extended in the flight configuration, and a yaw control arm attachment elbow shown in cutaway to reveal a mechanical drive mechanism inside;

FIG. 23 is a top view of the unit shown in FIGS. 21 and 22 showing the rotor blade and yaw control elements extended in the flight configuration;

FIG. 24 is a side view of the unit shown in FIGS. 21-23 showing the rotor blade and yaw control elements folded in a stowed configuration;

FIG. 25 is a perspective view of yet another rotorcraft unit of the present disclosure showing the unit having a single rotor system appended to an upper end of the body, and electrically driven variable thrust yaw-control elements and sensors appended to a mid-section of the body, and showing the yaw control elements extended in a flight configuration;

FIG. 26 is a perspective view of the unit shown in FIG. 25 showing the rotor blade and yaw-control elements folded in a stowed configuration; and

FIG. 27 is a diagrammatic view of the unit shown in FIGS. 4-8 showing the interchangeable modular components of the unit, and also showing various sub-components of each module.

### DETAILED DESCRIPTION OF THE DRAWINGS

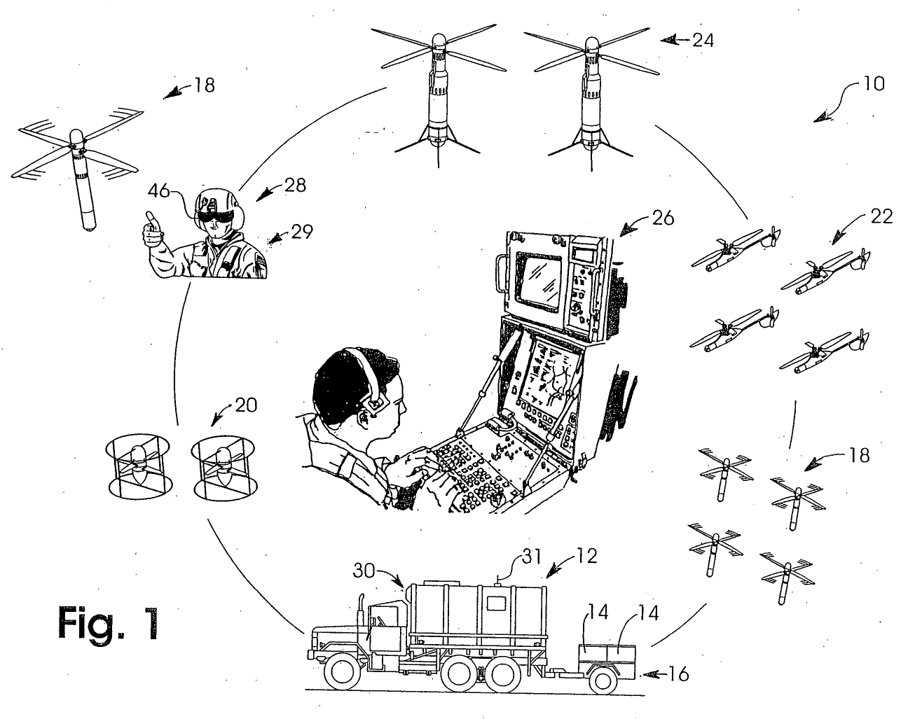

An integrated micro-rotorcraft system 10 includes a mobile command center 12 and various radio-controlled or self-guided micro-rotorcraft units, described in detail below. Illustrative components of integrated system 10 are shown in FIG. 1, for example. In general, the micro-rotorcraft units of integrated system 10 are miniature to provide remote surveillance and communication capabilities. Each unit is linked to the mobile command center 12 via an integrated data network. As is discussed in more detail below, each of the micro-rotorcraft units is able to survey remote areas and relay back real-time information including pictures of the tactical situation from numerous perspectives. Further, each unit is capable of rapidly deploying assets to new areas. The micro-rotorcraft units are able to act in coordination with each other and with the mobile command center 12 to perform a desired function such as search and rescue, observation, inspection, sampling, etc.

Micro-rotorcraft units may be remotely controlled by operators at the mobile command center 12 and may be pre-programmed to perform a set of instructions autonomously in the event that contact is lost between the particular micro-rotorcraft unit and the mobile command unit 12, or when insuring stealth or secrecy is required. In this autonomous mode, micro-rotorcraft units operate without direct input from the mobile command unit 12 and are capable of sending data to a data hub without revealing the position of the data hub.

Due at least in part to their small size, each micro-rotorcraft unit is capable of acting as an anti-personnel weapon by locating and striking individual combatants silently and from any direction. Illustrative system 10 may include up to one thousand micro-rotorcraft units. Each unit includes a payload module which may comprise video cameras (visible light and infrared), sensors (biological and chemical), munitions (explosive and incendiary), etc. Further each unit includes a navigation system, telemetry uplink and downlink capability, and autonomous autopilot capability. System 10 is capable of fusing a picture of the environment and taking coordinated action. Fitted with telemetry and data uplink/downlink electronics, each micro-rotorcraft unit may be operated from a central command center, a satellite, or an orbiting aircraft, such as a fixed-wing “Predator” drone, for example.

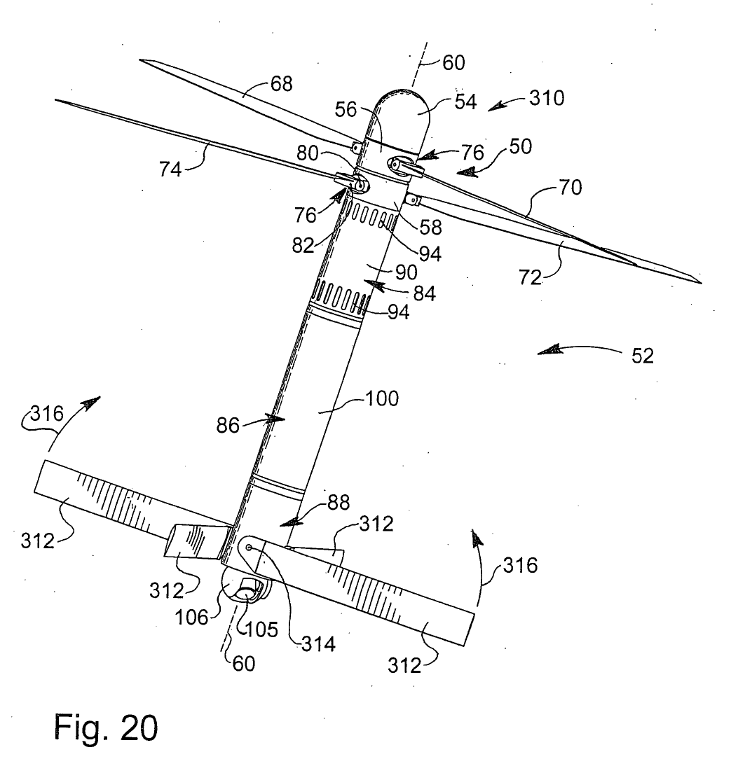

Looking again to FIG. 1, system 10 includes mobile command center 12, mobile base units 14 carried on a trailer 16 coupled to mobile command center 12, and illustrative micro-rotorcraft units 18, 20, 22, and 24. System 10 also includes micro-rotorcraft units 310, 330, 370, shown in FIGS. 20-26, as well. Within mobile command center 12 exists an integrated network 26, including various computers, monitors, etc., which allows units 18, 20, 22, 24, 310, 330, 370 to cooperate with each other and to remotely relay information to mobile command center 12. A video display and downlink helmet 28 of system 10 further communicates with units 18, 20, 22, 24, 310, 330, 370 to allow an operator 29 wearing helmet 28, but located away from mobile command center 12 and network 26, to receive data from and remotely control units 18, 20, 22, 24, 310, 330, 370, as is described in more detail below.

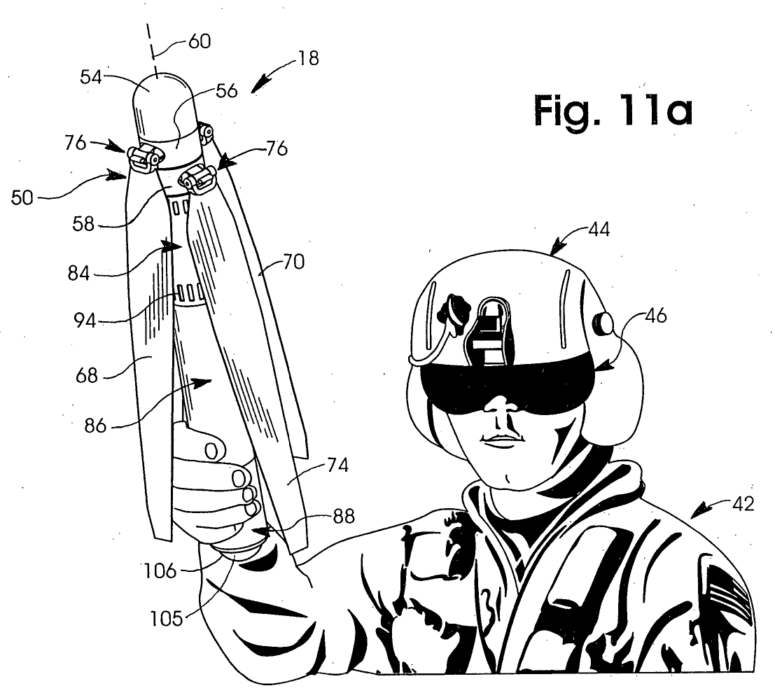

In operation, a pilot or operator 29 may be provided with display helmet 28, also shown in FIGS. 11a-11c, including video display glasses 46 which receive a video image from the camera or cameras 105 located at the base of payload module 88 to allow pilot or operator 29 to control the flight path of unit 18 (or any other unit) through a small joystick (not shown) or other portable control device, for example. An on-board autopilot program enhances pilot control and stabilizes the aircraft in three dimensions (yaw, pitch, and roll).

Alternatively, unit 18 includes on-board electronics which can be pre-programmed to follow a specified flight path based on GPS coordinates, for example. Preprogrammed flight reduces pilot workload so operator 29 is better able to observe the surrounding terrain projected through video display glasses 46 of helmet 28. Preprogrammed flight is also useful in fixed surveillance operations where station-keeping is important, such as in search and rescue operations, for example, where an orthogonal grid search pattern may be desirable, and tactical operations, for example, where autonomous munitions may be intended to hit stationary targets such as buildings or parked aircraft, for example, or targets outside of the range of the telemetry system.

Helmet 28 may also be programmed to sense motion of the head of operator 29 in order to control video camera 105 of unit 18. For example, upward and downward motion can slew camera 105 up and down, while side-to-side motion can rotate body 52 of unit 18 about body axis 60 thus providing a control system responsive to the natural movements of operator 29 in order to simplify the operator training which may be required to operate unit 18.

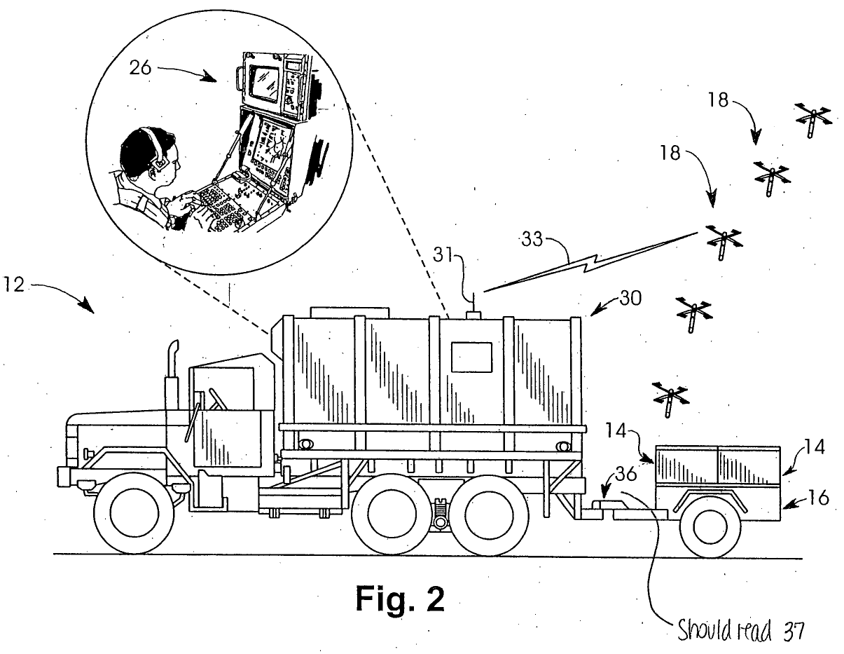

Looking now to FIG. 2, a more detailed view of the mobile command center 12 is provided. Illustrative mobile command center 12 includes an all-terrain vehicle 30. As shown in FIG. 2, trailer 16 is hitched to vehicle 30 and includes various mobile base units 14 carried thereon as is described below. In addition to vehicle 30, mobile command center 12 includes antenna 31 in communication with the network and computer system 26 to provide remote two-way communication with the various micro-rotorcraft units being deployed. Thus, antenna 31 is able to download data from the micro-rotorcraft units and upload data to the micro-rotorcraft units.

As mentioned above, mobile command center 12 includes various computer network systems 26, such as those illustratively shown in FIG. 2, which may be operated by users or personnel within mobile command center 12. Mobile command center 12 coordinates deployment of micro-rotorcraft units and processes data downloaded from deployed micro-rotorcraft units to support large-scale tactical operations, for example. Mobile command center 12 controls the systems onboard each micro-rotorcraft unit. These systems may be coordinated by mobile command center 12 to collect data or attack hostile forces remotely from any direction, over any terrain, obstacle or boundary, including geographical, physical, or political boundaries.

Integrated computer network system 26 within mobile command center 12 can process and display graphically all data downloaded from one or more deployed micro-rotorcraft units. This data may be combined with other sources of data, including remote sensors, satellites, manned aircraft ground units, etc., to present a fused, real-time picture of the tactical situation. As is discussed further below, data from sensors onboard the micro-rotorcraft units can help to locate and track chemical and/or biological releases, radioactive fallout, wanted persons or hostile forces, for example.

The illustrative vehicle 30 of mobile command center 12 is about 35 feet (4.57 meters) long, 15 (4.57 meters) feet wide, and 15 (4.57 meters) feet tall. The weight of the illustrative mobile command center 12 when unmanned or empty is approximately 20,000 pounds. Mobile command center 12 is capable of holding a crew of six and is powered by a gas generator (not shown). Although mobile command center 12 is disclosed and described above, it is within the scope of this disclosure for integrated system 10 to include a mobile command center 12 having other suitable specifications.

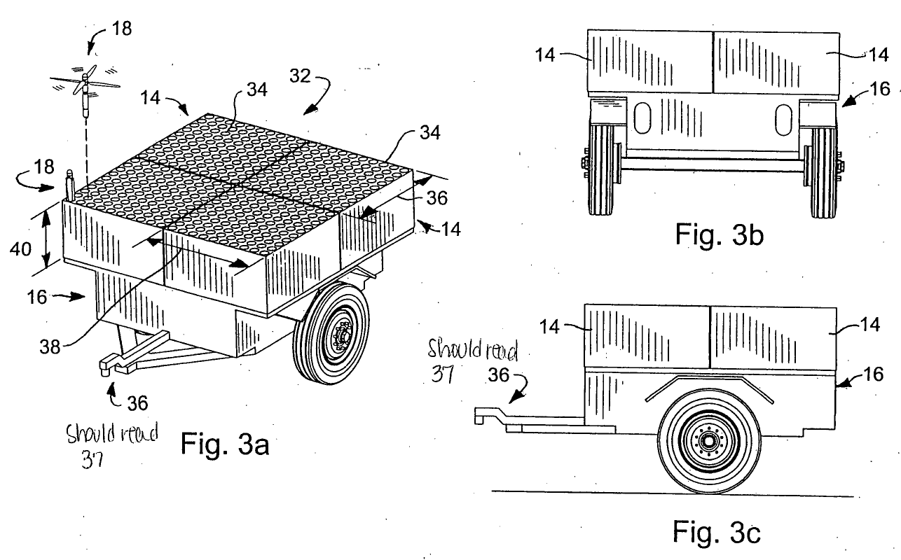

As mentioned above, a trailer 16 is hitched to mobile command center 12 by trailer hitch 36. As shown in FIGS. 3a-3c, illustrative trailer 16 is provided to carry an array 32 of mobile base units 14 of integrated system 10. Each illustrative mobile base unit 14 supports up to 100 micro-rotorcraft units and includes various power and data connections (not shown). As shown in FIG. 3a, each mobile base unit 14 includes multiple cavities 34 for stowing various micro-rotorcraft units therein, such as unit 18, for example. The power and data connections (not shown) are located within each cavity 34 so that when a micro-rotorcraft unit is stowed within a particular cavity 34, that unit is automatically connected to the power and data network 26. When linked to and used in conjunction with the mobile command center 12, the power connection automatically recharges the batteries (if provided) of each micro-rotorcraft unit placed therein, uploads data such as targeting information to each micro-rotorcraft , and launches each micro-rotorcraft unit. The power and data connections of mobile base units 14 may be remotely coupled to computer network 26 of mobile command center 12.

As shown in FIG. 3a, individual mobile base units 14 can be combined to produce a mobile base unit array 32 capable of holding large numbers of micro-rotorcraft units to support large scale tactical operations. As shown in FIGS. 3a-3c, mobile base units 14 are carried on trailer 16. However, it is also within the scope of this disclosure for mobile base units 14 to be transported by other suitable means, such as on trucks or aircraft such as helicopters, for example. Electric power is supplied to each mobile base unit 14 via a host vehicle or an optional gas-powered electric generator (not shown), for example.

The illustrative mobile base units 14 of system 10 each have a length 36 of 4 feet (1.22 meters), a width 38 of 4 feet (1.22 meters), and a height 40 of 2 feet (0.61 meters). As mentioned above, each illustrative mobile base unit 14 has the capacity to hold up to 100 micro-rotorcraft units. Further, illustrative mobile base units 14 each weigh approximately 100 pounds when empty and approximately 400 pounds when fully loaded with micro-rotorcrafts units. Illustratively, the power required for each mobile base unit 14 is at approximately 12 to 30 volts of direct current.

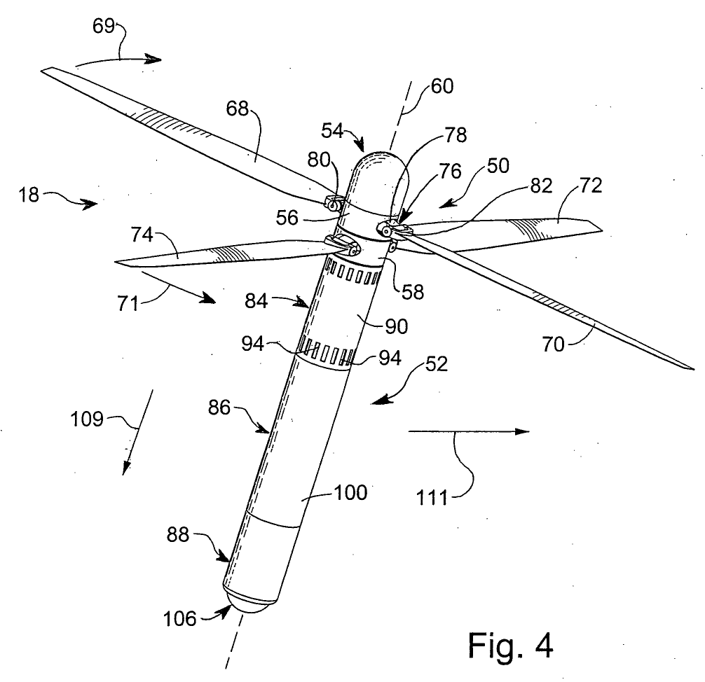

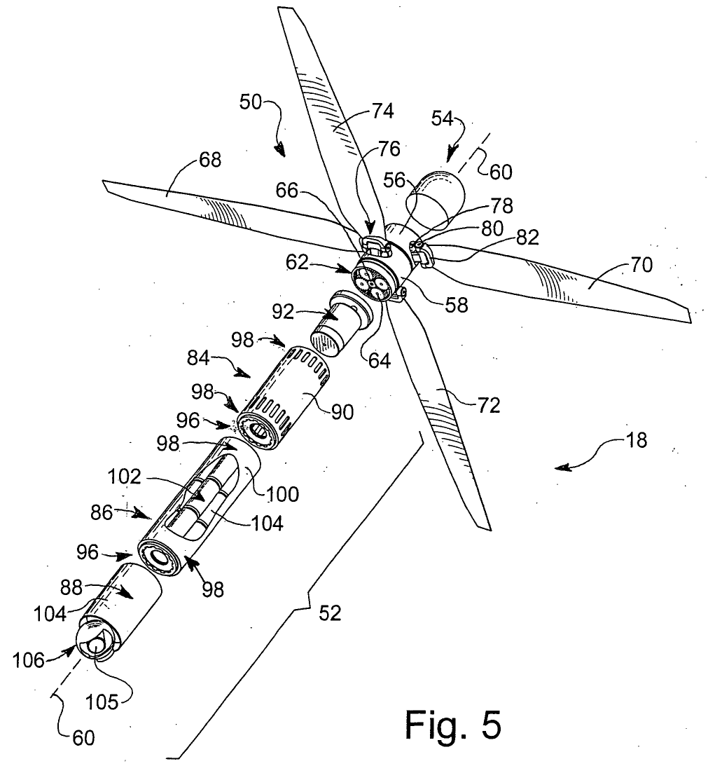

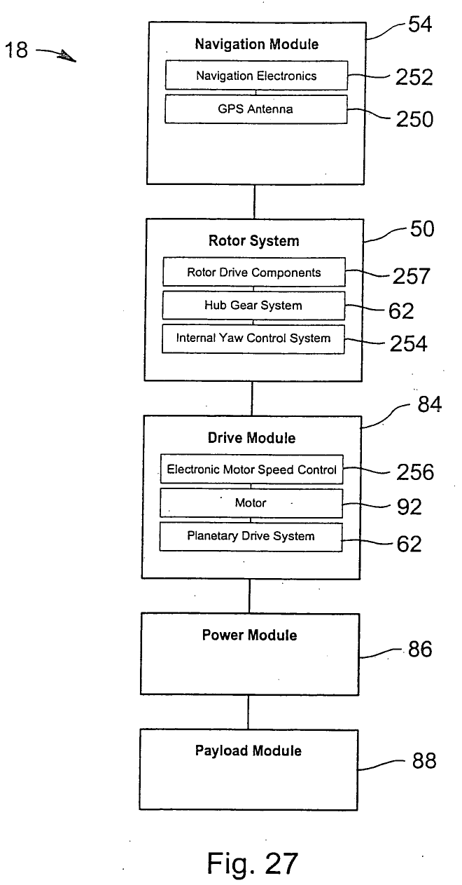

Looking now to FIGS. 4 and 5, micro-rotorcraft unit 18 of system 10 is provided. Unit 18 is miniature in size and includes a rotor system 50, an elongated modular body 52, and a navigation system module 54 having global positioning system (GPS) network capabilities. Illustrative navigation module 54 houses a GPS antenna 250 and associated electronics 252 (see FIG. 27). The navigation system of unit 18 may be satellite based, such as the GPS network described above, radio based including radio aids such as Omega, LORAN TACON, and VOR, for example, or the navigation system may be self-contained, such as an inertial navigation system, for example. Additionally, unit 18, and all other units described herein, may be navigated by remote control signals from mobile command center 12 or operator 29 with helmet 28, for example.

Illustrative rotor system 50 is also miniature in size and includes a first hub 56 and a second hub 58 coupled to first hub 56 to create a co-axial rotor system. Navigation module 54 is coupled to upper hub 56 of rotor system 50, as shown in FIGS. 4 and 5. First and second hubs 56, 58 are capable of rotating in the same direction and in opposite directions about a body axis 60 of unit 18. As shown in FIG. 5, a gear system 62 is provided for operating hub 58 which illustratively includes four peripheral gears 64 in communication with a central gear 66 which is connected to a motor 92. A similar gear system (not shown) is provided for operation of hub 56.

Rotor system 50 further includes upper blades 68, 70 coupled to first hub 56 and lower blades 72, 74 coupled to second hub 58. Upper blades 68, 70 generally rotate in direction 69 and are collectively and cyclically pitchable. Lower rotor blades 72, 74 generally rotate in direction 71 and are also collectively and cyclically pitchable. Although upper blades 68, 70 are shown to rotate in direction 69 and lower blades 72, 74 are shown to rotate in direction 71, it is within the scope of this disclosure for blades 68, 70 to rotate in direction 71 and for blades 72, 74 to rotate in direction 69. Body 52 of unit 18 generally does not rotate with rotor system 50, but maintains a stable heading (yaw) orientation through operation of an internal yaw control system 254 (see FIG. 27).

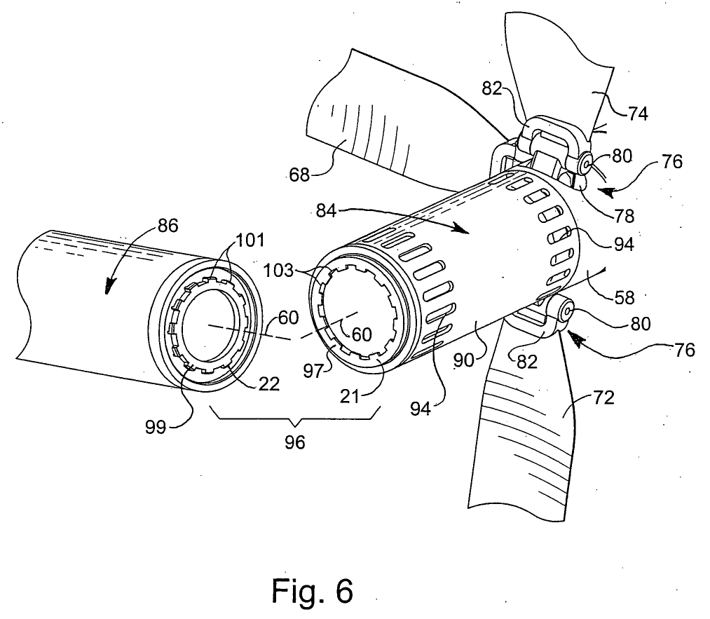

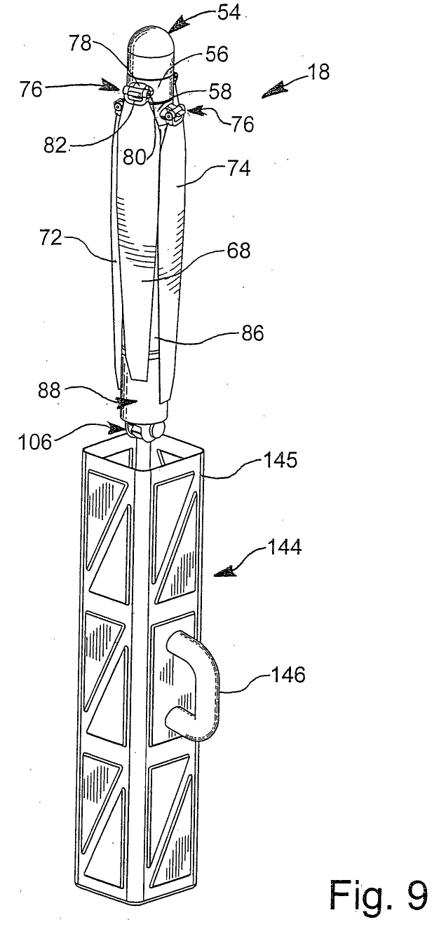

As shown more clearly in FIG. 6, each blade 68, 70, 72, 74 is coupled to the respective hub 56, 58 by a hinge 76 so that each blade 68, 70, 72, 74 is movable between an extended position, as shown in FIGS. 4, and 5 and a retracted or stowed position, as shown in FIGS. 9 and 11a. In the stowed position, blades 68, 70, 72, 74 lie generally adjacent to body 52 and in parallel relation to body axis 60. While in the extended position, however, blades 68, 70, 72, 74 are generally perpendicular to axis 60. In addition to allowing blades 68, 70, 72, 74 to move between the stowed position and the retracted position, hinges 76 also permit each respective blade 68, 70, 72, 74 to pivot so that blades 68, 70, 72, 74 are able to steer unit 18 in various directions for maneuvering around various obstacles and over certain terrain.

As shown in FIGS. 4, 5 and 6, each hinge 76 includes a base 78 coupled to the respective hub 56, 58, a pin 80 coupled to base 78, and a grip 82 coupled to pin 80 and to respective blade 68, 70, 72, 74. Grip 82 is pivotable about an axis 85 through pin 80 to move the respective blade between the extended and stowed positions. Pin 80 and grip 82 are both rotatable together in a clockwise direction and a counter-clockwise direction relative to base 78 to rotate the respective blade attached thereto about an axis (not shown) along a length of each respective blade in order to steer and maneuver unit 18. Hinges 76 are operable independently of each other.

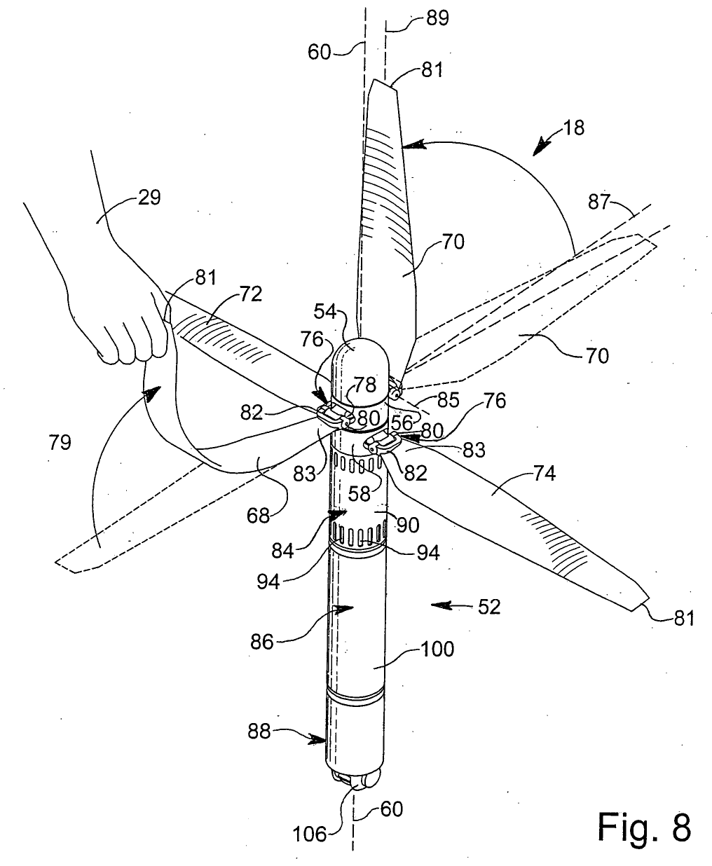

Illustrative rotor blades 68, 70, 72, 74 are molded of a high-impact plastics material such as, for example, nylon, polycarbonate, polyphenylene oxide, or flexible polyurethane and can withstand repeated crashes and rough handling, as is described in more detail below, with little or no damage. As shown in FIG. 8, for example, rotor blade 68 is shown being flexed by an operator 29 through a flexing angle 79 of up to 180 degrees where a tip 81 of blade 68 touches a root 83 of blade 68. Rotor blade 70, for example, is shown foldable about flapping axis 85 through pin 80 past an upper flapping limit 87 until a rotor blade longitudinal axis 89 is generally parallel to body axis 60. In addition to improving durability of unit 18, folding rotor blades 68, 70, 72, 74 past an upper flapping limit 87 toward axis 60 can improve launch stability of unit 18 when deployed from aircraft at high speed.

Unlike some aerial devices that passively derive lift through autorotation of a rotor system and passage of air upward through a rotor system, unit 18 is self-propelled and derives lift by forcing air downward through rotor system 50. However, unit 18 may also operate to passively derive lift through autorotation of a rotor system and passage of air upward through the rotor system. In operation, motor 92 drives rotor system 50 to develop a thrust force in direction 109 (as shown in FIG. 4) that lifts unit 18 into the air. Cyclic thrust forces from upper and lower rotor blades 68, 70, 72, 74 tilt rotor system 50 relative to the horizontal, and tilt body 52, axis 60 and thrust direction 109 relative to the vertical, so that unit 18 flies generally in a horizontal flight direction 111.

While rotor system 50 is disclosed and described above as having cyclically pitchable rotor blades 68, 70, 72, 74 for lateral flight control, rotor system 50 may also be gimbaled to tilt relative to elongated modular body 52. Tilt of rotor system 50 relative to the horizontal, while body 52 remains substantially vertical, redirects thrust force 109 away from to the vertical so that unit 18 flies in a generally horizontal flight direction 111. Tilt of rotor system 50 relative to body 52 effectively kinks or bends body 52 below rotor system 50. Motor 92 may be directly coupled to rotor system 50 and configured to tilt along with rotor system 50, or may be fixed within body 52 and connected to rotor system 50 via universal joint means (not shown).

Body 52 of unit 18 is coupled to rotor system 50 and extends along axis 60 of unit 18, as shown in FIGS. 4, 5, 7 and 8. As is discussed in more detail below, body 52 is small in size so that micro-rotorcraft unit 18 is hand-held and may be carried or transported by a single operator. As mentioned above, body 52 is modular and includes multiple interchangeable components. Illustratively, body 52 includes a drive module 84, a power module 86, and a payload module 88. As shown in FIGS. 4, 5, 7 and 8, for example, drive module 84 is coupled to rotor system 50, power module 86 is coupled to drive module 84, and payload module 88 is coupled to power module 86. The modular components of body 52 are interchangeable with each other if a different order along axis 60 is desired. It is also within the scope of this disclosure to include a unit 18 having other suitable modular components, as well, in addition to those illustrated in the accompanying figures. Illustratively, body 52 is approximately 15-19 inches (38.10-48.26 cm) in length.

As shown in FIG. 5, drive module 84 includes an outer cover 90 and a power component, such as an electric motor 92, received within cover 90. Module 84 also houses planetary drive system 62 and an electronic motor speed controller 256 (see FIG. 27). The electronic motor speed controller is coupled to motor 92. Illustratively, motor 92 is a compact, 400-watt, high-efficiency brushless electric motor capable of operating silently to maintain stealth and secrecy of unit 18 as unit 18 travels over various obstacles and terrain. However, it is within the scope of this disclosure to include other suitable motors and/or power components as well. For example, drive module 84 may house an internal combustion engine. Cover 90 includes air vents 94 to help prevent motor 92 from overheating within cover 90.

As shown in FIGS. 5 and 6, a module coupling 96 is provided so that each module of body 52 may be easily coupled to and uncoupled from each other. Module coupling 96 includes toothed female coupling ring 97 coupled to one end of each module and a male coupling ring 99 coupled to the other end of each module.

As shown in FIG. 6, toothed female coupler ring 97 of modular quick-change coupling 96 is appended to the lower end of drive module 84, and toothed male coupling ring 99 is appended to the upper end of power module 86. Female coupling ring 97 and male coupling ring 99 cooperate to form quick-disconnect module coupling 96. A plurality of male teeth 101, each having a ramp profile and dead-stop for cam-action locking, are provided on male coupling ring 99. An equal number of female receiving areas 103 are provided in female coupling ring 97.

In operation, male coupling ring 99 is inserted into female coupling ring 97 with a quick twisting action thereby securely retaining drive module 84 to power module 86. Modules 54, 84, 86, 88 and hubs 56, 58 each have a similar coupling which makes them quickly interchangeable. For instance, a depleted battery power module 86 need not be recharged, but can be quickly replaced at the end of a flight. In a similar fashion, payload module 88 (which is shown to be adapted for use with video camera 105) may be quickly replaced at the end of a mission with an alternative payload module (not shown) having a chemical sensor adapted for use in a different mission, for example.

Similar to drive module 84, power module 86 also includes an outer cover 100. Battery pack 102 of module 86 is contained within cover 100. Batteries 104 of pack 102 may be rechargeable, such as Li-polymer batteries, or single use such as LiMnO₂ batteries, for example, and may have an operating life of 1 to 3 hours, for example. As shown in FIG. 5, power module 86 also includes module coupling 96 at each end 98 of cover 100.

Payload module 88 also includes a cover 104. Payload module 88 is provided to carry various items within cover 104 such as explosive or incendiary munitions and biological and chemical sensors. Payload module 88 is coupled to a lower end of power module 86 and contains mission specific computer electronics, autopilot systems, sensors and/or explosive warhead (not shown).

Payload module 88 also accommodates a pivotable video camera 105 and a camera pivot mount 106 for slewing camera 105 in a vertical direction. Video camera 105 may also rotate 360 degrees about axis 60 to survey and take pictures of the surrounding terrain and environment for relay back to mobile command center 12, for example. Video camera 105 allows a remote operator to silently look into windows, see over hills, observe from great heights, and operate over any terrain or obstacle.

Although unit 18 is miniature in size, unit 18 is capable of carrying a variety of payloads ranging from visible and infrared video cameras to electromagnetic and chemical sensors, for example. Unit 18 is able to carry such sensors over long distances and at great heights above the local terrain. This can dramatically increase the situational awareness of forces on the ground, for example.

Illustrative payload module 88 is capable of carrying four to sixteen ounces of plastic explosives allowing unit 18 to act as a highly potent expendable munition for special operations where stealth and precision are required. Unit 18 is also able to act as a target beacon for much larger laser guided munitions dropped from an orbiting aircraft, for example.

A feature of unit 18 is that much of the weight of elongated body 52, such as for instance, batteries 102 in power module 86 and payloads (not shown) in payload module 88, is located far below the effective plane of rotation of rotor system 50. The pendulum effect of this offset weight being drawn downward by gravity can act to passively stabilize co-axial rotor system 50 and unit 18 in flight in the roll and pitch directions.

Several units 18 can be deployed with various payload modules to form a system of guided sensors providing a picture of the environment from many perspectives and vantage points simultaneously. FIG. 2 shows the central computerized command center 12 controlling units 18 of the current disclosure via electronic telemetry uplink and downlink 33.

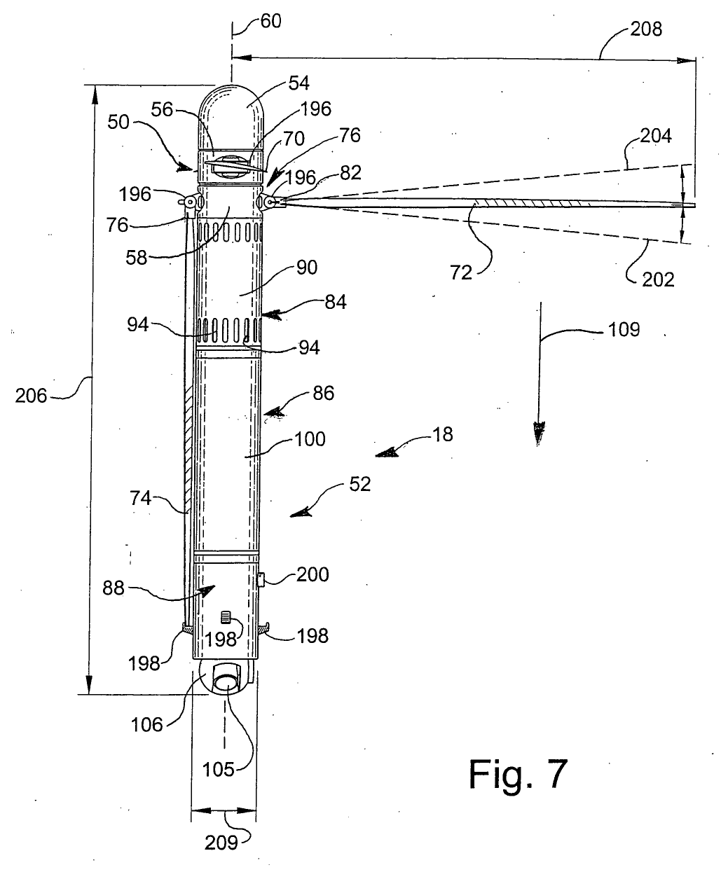

Looking now to FIG. 7, unit 18 includes additional features such as torsion springs 196 for biasing each rotor blade 68, 70, 72, 74 away from their folded or retracted configuration generally parallel to body axis 60. Blade latches 198 are provided to retain blades 68, 70, 72, 74 in the folded configuration until blade latches 198 are unengaged by an operator by means of a surface control such as a thumb button 200, for example, or by remote control.

Springs 196 are configured to extend blades 68, 70, 72, 74 only to a lower flapping limit 202. Blades 68, 70, 72, 74 are then free to flap in flight between an upper flapping limit 204, about ten degrees above the horizontal, and lower flapping limit 202, about ten degrees below the horizontal. Flapping motion of blades 68, 70, 72, 74 above upper flapping limit 204 and below lower flapping limit 202 are resisted by springs 196 or other means.

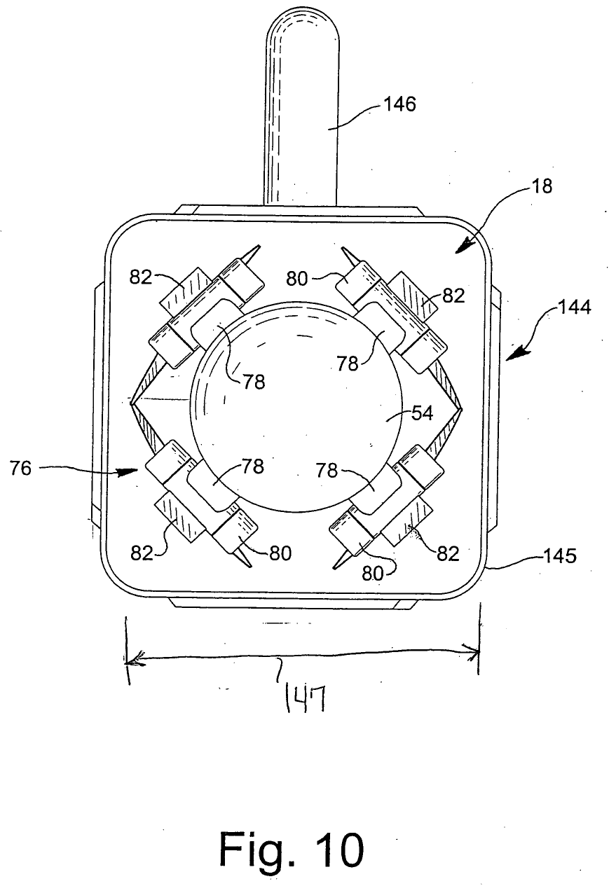

A body length 206 of illustrative unit 18 is about 17-19 inches (43.18-48.26 cm), while a blade span 208 is about 14.5 inches (36.83 cm), thus making unit 18 miniature or small in size. Unit 18 generally has an aspect ratio of greater than about 2:1, but is often in the range of 5:1 to 10:1. The term “aspect ratio” is herein defined as the ratio between body length 206 and mean body diameter 209. Body axis 60 is defined as the axis of longest dimension of body portion 52. For the purpose of determining aspect ratio, the body length includes the sum of the lengths of all coupled body modules taken along the body axis including the length of the rotor system module and all modules coupled to the rotor system module. Looking now to FIGS. 9 and 10, unit 18 is configured for storage in a storage compartment or carrying case 144. Carrying case 144 includes a hollow body 145 and a handle 146 coupled to body 145. Body 145 is generally square in cross-section to accommodate folded rotor blades 68, 70, 72, 74 and other folding elements of unit 18. Side length 147 of body 145 is about 4 inches (10.16 cm). When blades 68,70, 72, 74 are folded to the stowed position, illustrative unit 18 has a diameter of about 4 inches (10.16 cm) inches.

With such a small or miniature size, and a weight of approximately 3 pounds, a single operator 29 can carry up to ten units 18 in a backpack. Other specifications of the illustrative unit 18 include a length of body 52 of approximately 18 inches (45.72 cm), a diameter of rotor system 50 of approximately 30 inches (76.20 cm), a maximum horizontal speed of approximately 30-40 miles per hour (depending on the payload weight), a maximum vertical speed of approximately 10 to 15 feet per second (3.05-4.57 meters per second) (also depending on the payload weight), a maximum altitude of approximately 7,000 feet (2,133 meters), a payload of 4 to 16 ounces, a range of approximately 5 to 60 miles, a hover accuracy of plus or minus approximately 3 feet 91.44 cm), and a gust tolerance of approximately 30 miles per hour. Video camera 105, navigation module 54, the telemetry uplink and downlink, autonomous autopilot and those things carried within payload module 88 are considered to be part of the payload which unit 18 can carry. Although various specifications of unit 18 are disclosed and described herein, it is within the scope of this disclosure for unit 18 to have other suitable specifications and operational capabilities as well.

Unit 18 can be quickly reconfigured within a few seconds for a variety of roles in remote surveillance and tactical operations via interchangeable payload and power modules. Because of the miniature size of unit 18, a single operator is able to reconfigure the interchangeable modules of unit 18 in a generally fast and efficient manner. Illustrative unit 18 includes video camera 105; however, unit 18 may also be fitted with more sophisticated telemetry and data uplink electronics to be operated from a satellite or orbiting aircraft, such as a Predator drone, for example. Unit 18 can enhance situational awareness and project force at extreme distances irrespective of the intervening terrain or presence of hostile forces. Unit 18 can be configured in the field for a variety of missions quickly and economically.

Unit 18 can be controlled by central computer system 26. Multiple units 18 may be launched en masse from mobile base unit 14, for example, to form a swarm of miniature cruise missiles for use in search-and-rescue operations or anti-personnel operations against entrenched or concealed combatants, for example. Further, unit 18 may be dropped from an aircraft to reconnoiter closer to the ground much like a sono-buoy is dropped into the ocean from a ship or helicopter to search for submarines, for example.

FIGS. 11a-11c illustrate a first manual method for deploying and operating unit 18. As mentioned before, hand-held unit 18 is miniature in size to allow operator 29 to grasp body 52 of unit 18 and hold unit 18 in a near-vertical orientation in preparation for flight, as shown in FIG. 11a, for example. Body 52 is adapted to the human hand and is about 2 inches (5.08 cm) in diameter in the illustrative embodiment shown. Rotor blades 68, 70, 72, 74 are loosely folded along body 52 in the stowed position.

In FIG. 11b, operator 29 manually or remotely causes blades 68, 70, 72, 74 to extend from their stowed configuration to a flight or extended configuration (as by pushbutton 200 shown in FIG. 7, for example). In FIG. 11c, operator 29 then initiates powered rotation of rotor system 50 manually or through remote means, and unit 18 flies away under its own power in direction 111, for example. Illustrative unit 18 does not require landing gear for deployment because unit 18 is hand-launched.

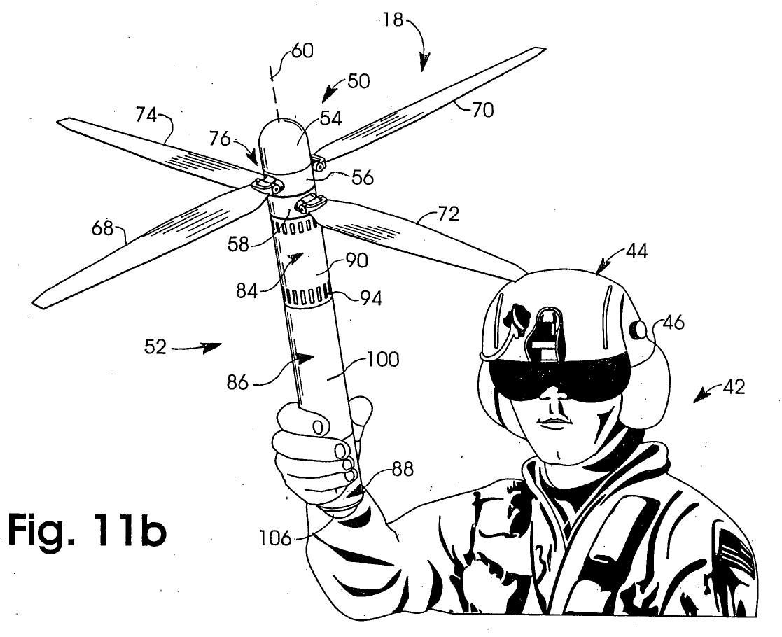

FIG. 12 illustrates an automatic method of deploying unit or units 18 from an aircraft 176 fitted with multiple storage carriers 144. Unit 18 is ejected from aircraft 176 and a parachute 178 appended to one end of unit 18 is deployed to slow and stabilize the flight of unit 18 as unit 18 descends to a lower altitude. Next, extendable elements, such as rotor blades 68, 70, 72, 74 are extended into their flight configurations. Parachute 178 is then released and rotor blades 68, 70, 72, 74 are driven under power provided by modules 84, 86 so that unit 18 is capable of flying away under its own power in a generally horizontal direction 111.

Refer now back to FIG. 3a which illustrates an automatic method of deploying unit 18 from mobile base unit 14. Prior to launch, unit or units 18 must be loaded into mobile base units 14. To load unit 18, an operator 29 folds the blades 68, 70, 72, 74 of unit 18 to the retracted or stowed position and inserts unit 18 into the receptacle or cavity 34 of mobile base unit 14, as shown in FIG. 3a, for example. As mentioned above data and electrical connections are automatically established. To launch unit 18, as shown in FIG. 3a, mobile base unit 14 automatically raises unit 18 into a launch position. Unit 18 is then directed to open rotor blades 68, 70, 72, 74 to the extended position and fly away under its own power. Although the manual and automatic methods for deploying a micro-rotorcraft unit discussed above are made with reference to unit 18, it is within the scope of this disclosure for the other units 20, 22,24, 310, 330, 370 described herein to be deployed in the same or similar manner.

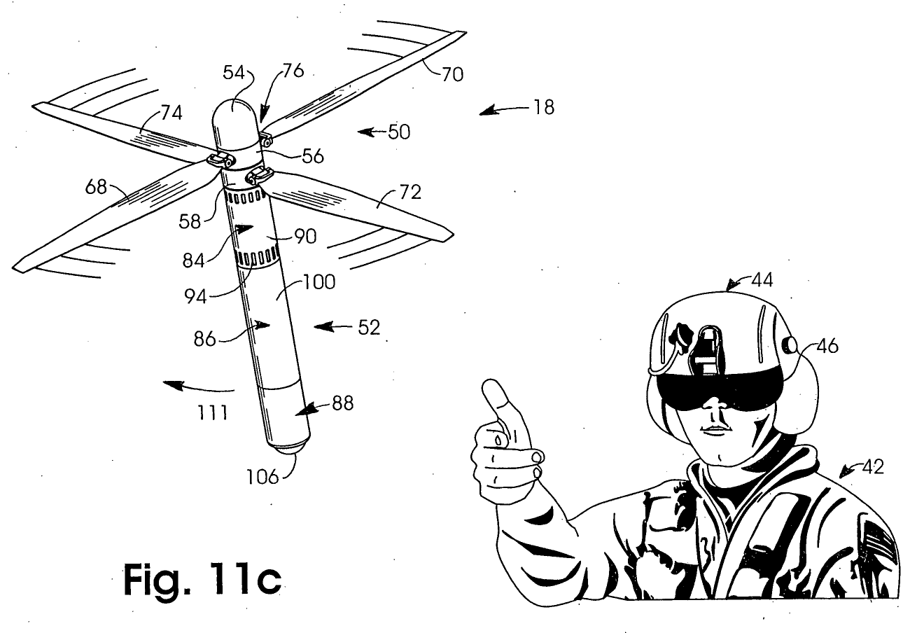

FIGS. 13a-13c illustrate a method for landing or recovering unit 18. Illustrative unit 18 does not require any landing gear because rotor blades 68, 70, 72, 74 are foldable upward and downward toward body axis 60, and, at the end of a flight, body 52 simply tips sideways onto the ground. In FIG. 13a, unit 18 is shown descending from altitude in direction 179. In FIG. 13b, unit 18 has descended to a point where the lower end of body 52 is resting on or near the ground at which time power to rotor system 50 is automatically shut off. In FIG. 13c, rotor system 50 has decelerated to the point where the vertical orientation of body 52 can no longer be maintained causing unit 18 to fall on its side with rotor blades 68, 70, 72, 74 flexing and folding past a flapping angle of about 10 degrees upon contact with the ground to reduce the possibility of crash damage. The operator 29 is then able to stow folded unit 18 in a backpack or the trunk of a car. Because of the features of unit 18, unit 18 can be landed repeatedly in this manner with little or no damage. It is within the scope of this disclosure, however, to provide landing gear for unit 18 to allow unit 18 to land in an upright position, for example.

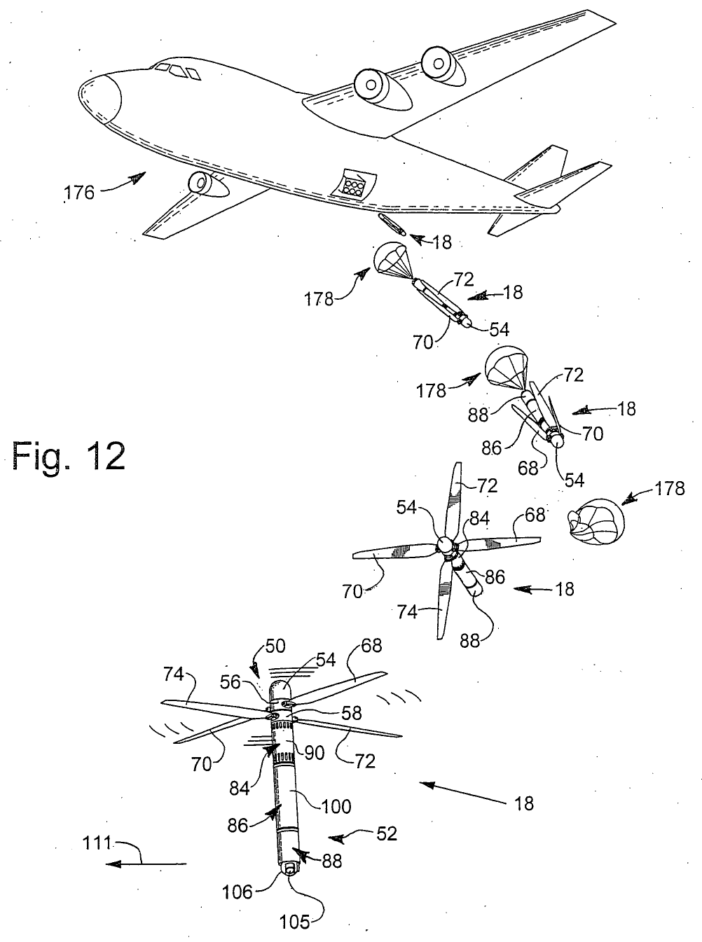

Looking now to FIGS. 14-16, another micro-rotorcraft unit 20 is provided for use with integrated system 10. Unit 20 is also miniature in size and includes a central body 110 having an upper portion 112, a lower portion 114, and a rotor system 116 coupled to and positioned between the upper and lower portions 112, 114. Unit 20 further includes an outer cage 118 coupled to central body 10. Particularly, cage 118 is coupled to upper portion 112 and lower portion 114 of body 110.

Illustrative cage 118 includes a circular upper base 120, a circular lower base 122, and four vertical supports 124 coupled to and extending between each of the upper and lower bases 120, 122. An upper, horizontal support 126 is coupled to upper base 120 and upper portion 112 of central body 110. Illustratively, support 126 is received in part through an aperture 128 of upper portion 112. However, it is within the scope of this disclosure to couple support 126 to upper portion 112 in other suitable ways such as welding, for example. A lower, horizontal support 130 is coupled to lower base 122 by a small vertical support 132. Illustratively, body 110 is generally centered within cage 118. Illustrative cage 118 is made of titanium memory wire. However, it is within the scope of this disclosure for cage 118 to be made of other suitable materials such as plastics, etc. Cage 118 protects rotor blades 134, 136, 138, 140 from contacting walls, floors, ceilings, etc. as unit 20 flies around or through various obstacles and terrain inside of buildings or other interior spaces. Cage 118 of unit 20 allows unit 20 to take off from a standing position, rather than having to be launched from mobile base unit 14, for example.

Rotor system 116 of unit 20 is similar to rotor system 50 of unit 18, described above. As such, co-axial rotor system 116 includes first hub 56 and second hub 58. Two oppositely extending blades 134, 136 are coupled to first hub 56, and oppositely extending blades 138, 140 are coupled to second hub 58 to rotate in opposite directions. Each blade 134, 136, 138, 140 is coupled to respective hub 56, 58 by a type of clamp or grip 82. Like unit 18, blades 134, 136, 138, 140 of unit 20 are free to flap in flight within a flapping zone above and below the horizontal. Unlike blades 68, 70, 72, 74 of unit 18, illustrative blades 134, 136, 138, 140 of unit 20 are not movable to a stowed position. However, it is within the scope of this disclosure to couple blades 134, 136, 138, 140 to respective hubs 56, 58 with hinges 76 to allow blades 134, 136, 138, 140 to move to a stowed position.

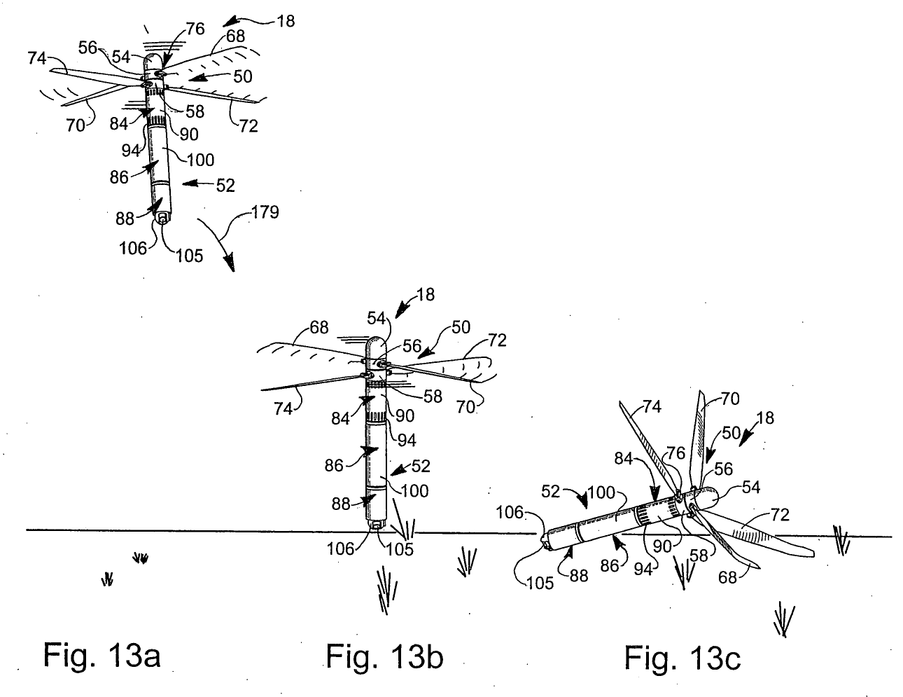

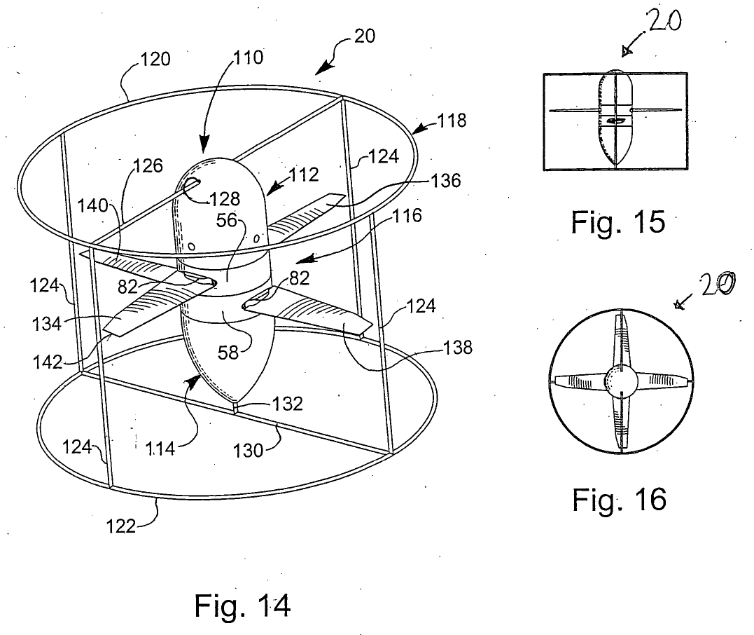

As shown in FIGS. 15 and 16, blades 134, 136, 138, 140 are contained within cage 118. Illustratively, and outer end 142 of each blade 134, 136, 138, 140 is spaced apart from vertical supports 124 and does not interfere with vertical supports 124. Blades 134, 136, 138, 140 are also collectively and cyclically pitchable in order to steer and maneuver unit 20.

Unit 20 also includes a motor (not shown) and batteries (not shown). . Further, unit 20 may also include a GPS navigation system, a visible light and infrared video cameral, telemetry uplink and downlink for communication with integrated network 26 of mobile command center 12. Unit 20 may also operate autonomously on autopilot, and may carry explosive and/or incendiary munitions and biological and/or chemical sensors. Each of these components operate like those described above with respect to unit 18. Further, each of these components may be contained within upper or lower portions 112, 114.

The small size of unit 20 allows a single operator 42 to be able to carry up to four units 20 in a field pack. Illustrative unit 20 weighs approximately eight ounces, has a rotor blade diameter of approximately 12 inches (30.48 cm), a height of approximately 8 inches (20.32 cm), a maximum horizontal speed of approximately 15 miles per hour, a maximum vertical speed of approximately 6 feet per second (1.83 meters per second), a maximum altitude of approximately 6,000 feet (1,830 meters), a maximum payload of approximately 3 ounces, a range of approximately 7 miles, a hover accuracy within about 6 inches (15.24 cm), and a gust tolerance of about 10 miles per hour.

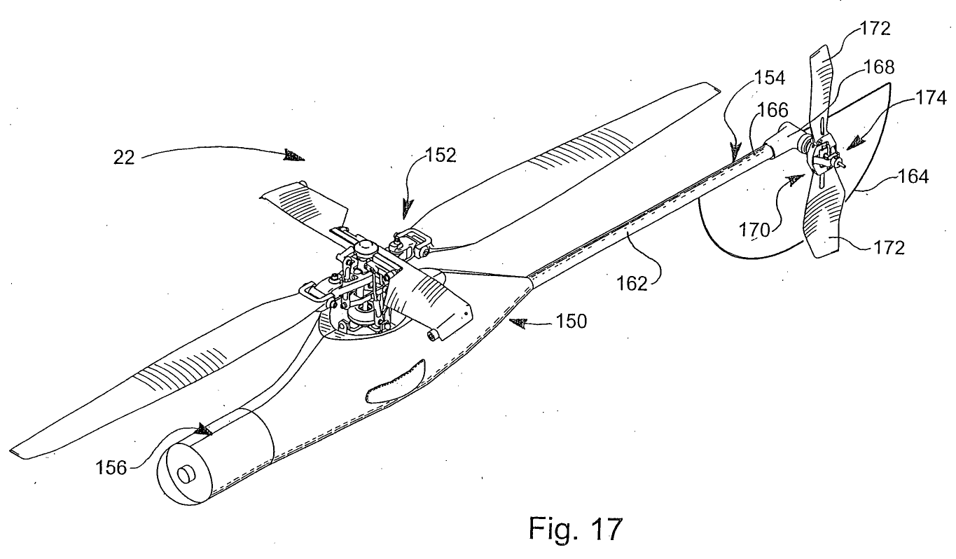

Looking now to FIG. 17, another micro-rotorcraft unit 22 is provided for use with system 10. Illustrative unit 22 is also miniature in size and includes a body 150, a rotor system 152 coupled to body 150, and a tail 154 coupled to body 150 as well. Similar to units 18, 20, discussed above, body 150 carries a silent electric motor (not shown) and rechargeable and/or single use batteries. A payload module 156 is coupled to body 150 and may include one or more of the following: a visible light and/or infrared video camera, a GPS navigation system, telemetry uplink and downlink with integrated system 26, autonomous autopilot software, explosive and/or incendiary munitions, and biological and/or chemical sensors. Illustrative unit 22 is capable of carrying a payload of approximately 4 to 8 ounces.

Illustrative rotor system 152 of unit 22 includes four flexible plastic rotor blades 158 coupled to a central hub 160 of rotor system 152. Blades 158 are foldable for compact storage and flexible to withstand repeated crashes and rough handling with little or no damage. As a result, unit 20 requires no landing gear and can be landed or recovered by way of the method illustrated in FIG. 13a-13c.

Tail assembly 154 of unit 22 includes an elongated boom 162, a semi-circular rotor guard 164 coupled to boom 162 and positioned to extend beyond an end 166 of boom 162. A gearbox 168 of tail assembly 154 is coupled to end 166 of boom 162 and variable thrust tail rotor system 170 is coupled to gearbox 168. Tail rotor system 170 includes two oppositely extending blades 172 coupled to a central hub 174 of tail assembly 154.

Illustrative units 22 are approximately 2.5 pounds allowing a single operator to carry up to ten units 22 in a field pack. Illustrative rotor system 152 has a rotor diameter of 24 inches (60.96 cm). A length of each unit 22 is approximately 30 inches (76.20 cm). Each unit 22 can attain a maximum horizontal speed of approximately 50 miles per hour, a maximum vertical speed of approximately 10 to 15 feet per second (3.05 to 4.57 meters per second), and a maximum altitude of approximately 7,000 feet (2,133 meters). Unit 22 has a range of approximately 20 to 60 miles with a hover accuracy of approximately plus or minus one foot (30.48 cm). Unit 22 is capable of carrying a payload of approximately 4 to 8 ounces at 30 miles per hour.

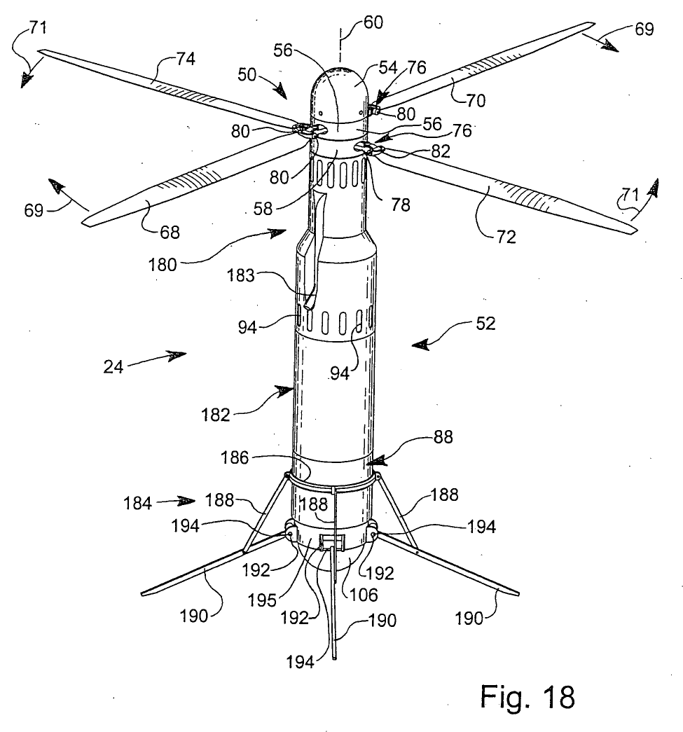

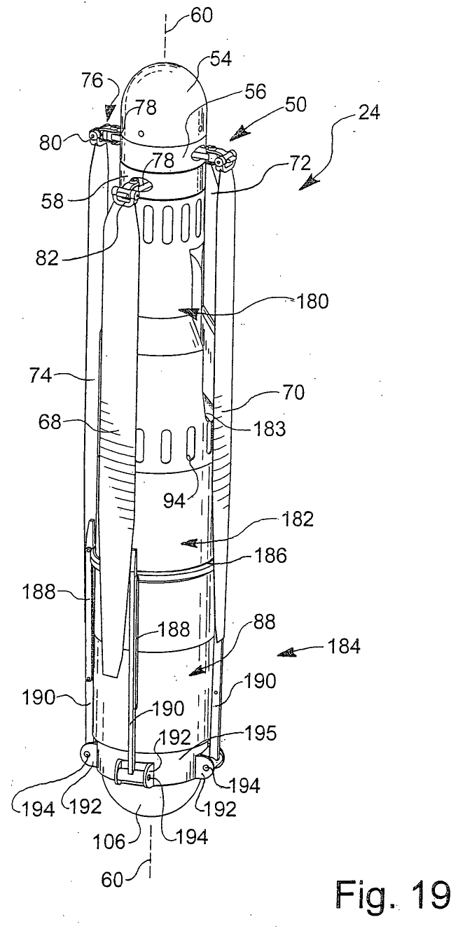

Looking now to FIGS. 18 and 19, another illustrative micro-rotorcraft unit 24 is provided for use with system 10. Unit 24 is similar in appearance to unit 18 in that unit 24 includes various interchangeable modules forming vertically extending, elongated body 52. For example, unit 24 includes navigation module 54, rotor system 50 coupled to navigation module 54, payload module 88, and video camera and/or sensor equipment 106 coupled to payload module 88. As mentioned above with respect to unit 18, the video camera may be a visible light and/or an infrared video camera, and the sensors may be biological and/or chemical sensing sensors among other. Unit 24 is also miniature in size for manual deployment by an operator, as discussed above with respect to unit 18.

Rotor system 50 of unit 24 is the same as or similar to rotor system 50 of unit 18 discussed above. Rotor system 50 includes upper blades 68, 70, and lower blades 72, 74 and the associated rotor drive components 257 (see FIG. 27) housed in upper and lower hubs 56, 58. Upper rotor blades 68, 70 are collectively and cyclically pitchable and generally rotate in rotor rotation direction 69. Lower rotor blades 72, 74 are collectively and cyclically pitchable and generally rotate in rotor rotation direction 71. Unit 24 is powered by an internal combustion gas engine (not shown) having an exhaust tube 183.

Unit 24 further includes a drive module 180 coupled to rotor system 50, and a power module 182 coupled to drive module 180. Drive module 180 includes an internal combustion gas fueled engine (not shown) and air vents 94 to prevent the engine from overheating, for example. Power module 182 includes a fuel tank (not shown) containing fuel for the gas fueled engine. The engine of unit 24 is a highly efficient diesel fuel engine. Illustratively, enough diesel fuel may be provided to permit unit 24 to fly for approximately two to four hours. A recoil pull-start (not shown) is provided for easy starting.

As mentioned above with respect to unit 18, rotor system 50 includes flexible plastic rotor blades 68, 70, 72, 74 which fold downward to a stowed position for compact storage. Plastic blades 68, 70, 72, 74 can withstand repeated crashes and rough handling with little or no damage. Although illustrative blades 68, 70, 72, 74 are made of plastic, it is within the scope of this disclosure to include rotor blades made of other materials such as metals, fibrous composites, etc.

Each illustrative miniature unit 24 is approximately 4-5 pounds allowing one operator to carry up to six units 24 each within protective carrying case 144, for example. The rotor blade diameter of rotor system 50 is approximately 36 to 48 inches (1.22 meters), the length of body 52 of unit 24 is approximately 36 inches (91.44 cm). The illustrative unit 24 is able to accelerate to a maximum horizontal speed of approximately 30 miles per hour, a maximum vertical speed of approximately 10 to 15 feet per second (4.57 meters per second), and to ascend to a maximum altitude of approximately 7,000 feet (2,133 meters). Illustrative unit 24 can carry a payload of approximately 1 to 2 pounds and can survey a range of up to approximately 180 miles while remaining in communication with integrated network 26. Unit 24 has a hover accuracy of plus or minus approximately 4 feet (1.22 meters) and a gust tolerance of approximately 30 miles per hour.

A miniature landing assembly 184 of unit 24 is coupled to payload module 88. Landing assembly 184 allows unit 24 to stand upright for landing and/or take-off, and allows unit 24 to be launched without the use of mobile base unit 14, for example. Landing assembly 184 includes a circular ring or brace 186 around payload module 88 and slideable along axis 60 and upper leg supports 188 each being pivotably coupled to brace 186 at one end, and pivotably coupled to a respective landing leg 190 of assembly 184 at another end. Illustratively, landing assembly 184 includes four support legs 188 equally spaced about brace 186 and four corresponding landing legs 190. However, it is within the scope of this disclosure to include a landing assembly having any suitable number of legs to maintain the body 110 of unit 24 in an upright position as shown in FIG. 18, for example.

Each lower leg 190 of landing assembly 184 is coupled to a hinge 192 by a pin 194 to allow each lower leg 190 to pivot about pin 194. Each hinge 192 is coupled to a lower ring or brace 195 around payload module 88. As shown in FIG. 18, landing assembly 184 is in an extended or launch position. Landing assembly 184 is movable between this launch position and a stowed position shown in FIG. 19. In the stowed position, upper legs 188 and lower legs 190 are pivoted upwardly to lie adjacent to body 110 of unit 24 in parallel relation to body axis 60. When landing assembly 184 (and rotor system 50) are in the stowed position, unit 24 may be placed within carrying case 144 for a user to easily carry and transport. As described above, carrying case 144 includes a hollow tube 145 for receiving unit 24 therein and a handle 146 coupled to tube 145 for a user to grasp when transporting carrying case 144.

In operation, rotorcraft unit 24 sits passively on the ground atop landing assembly 184. During launch, rotor system 50 is activated to develop a generally downward thrust force that lifts unit 24 into the air. Landing assembly 184, including landing legs 190, can either remain attached to unit 24 in flight and for subsequent landings, or can be dropped off or left on the ground to reduce flying weight.

Looking now to FIG. 20, another micro-rotorcraft unit 310 of the present disclosure is provided for use with system 10. Unit 310 has variable pitch, aerodynamic fins 312 coupled to payload module 88. Each fin 312 is pivotable about a hinge point 314 in direction 316 for storage alongside body portion 50. Like landing gear assembly 184, fins 312 may also be detached or dropped off in flight. Fins 312 can be used for yaw control during hovering flight, to increase directional stability in high-speed forward flight, and as landing or launch legs, for example.

In one method of deployment of the unit 310, fins 312 extend as unit 310 is dropped from an airplane at altitude. Rotor blades 68, 70, 72, 74 remain retracted alongside body portion 50 immediately after unit 310 is deployed. Fins 312 guide unit 310 in a controlled descent from altitude until such time as rotor blades 68, 70, 72, 74 are extended. Once blades 68, 70, 72, 74 are extended for flight, fins 312 may drop off to allow unit 310 to continue on its own power. Similar to the micro-rotorcraft units described above, unit 310 is also miniature in size and may be hand-held for manual deployment by an operator as well.

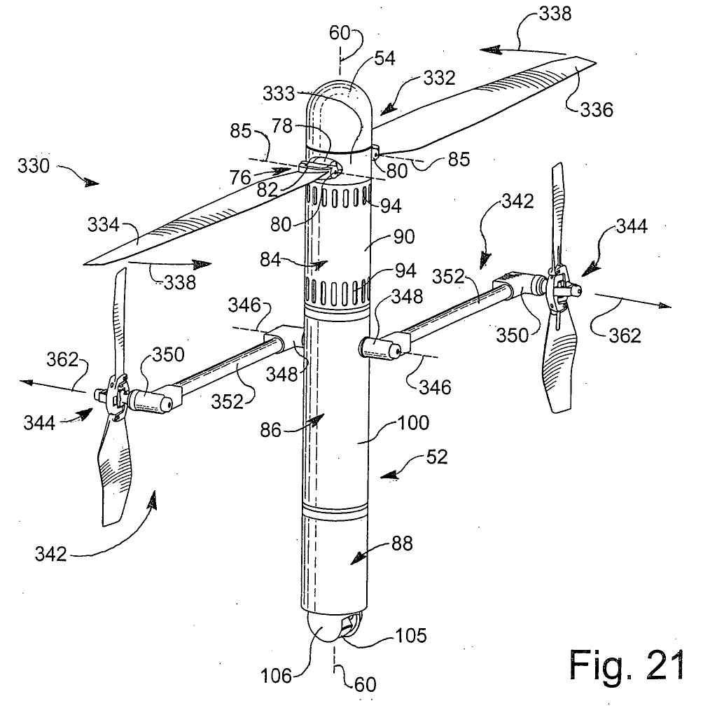

Looking now to FIGS. 21-24, another micro-rotorcraft unit 330 is provided. Unit 330 has a single rotor lifting system 332 including cyclically and collectively pitchable rotor blades 334, 336 rotating in direction 338 that are foldable about a folding axis 340 through each hinge pin 80. Rotor system 332 also includes a hub 333 to which each blade 334, 336 is coupled.

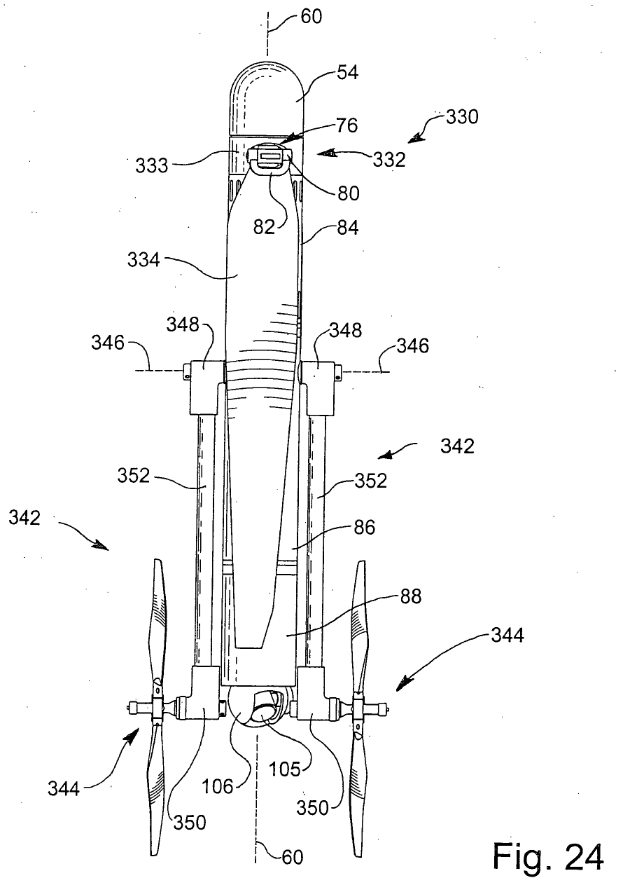

Yaw control outriggers 342 of unit 330 include collectively pitchable rotor systems 344 that fold or retract alongside power module 86 about a hinge axis 346 on rotatable gearboxes 348 coupled to power module 86. A gearbox 350 supports each rotor system 344 on an outer end of boom 352 and contains bevel gears (not shown). Yaw control outriggers 342 are movable between an extended position, as shown in FIG. 21, and a folded or retracted position, as shown in FIG. 24.

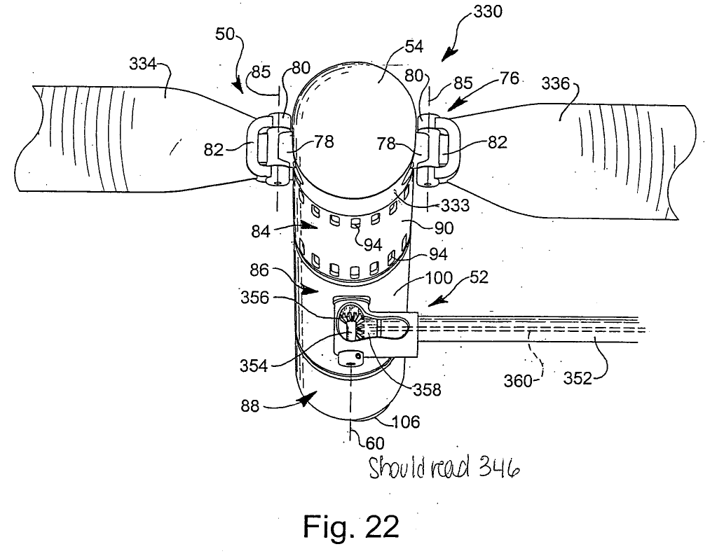

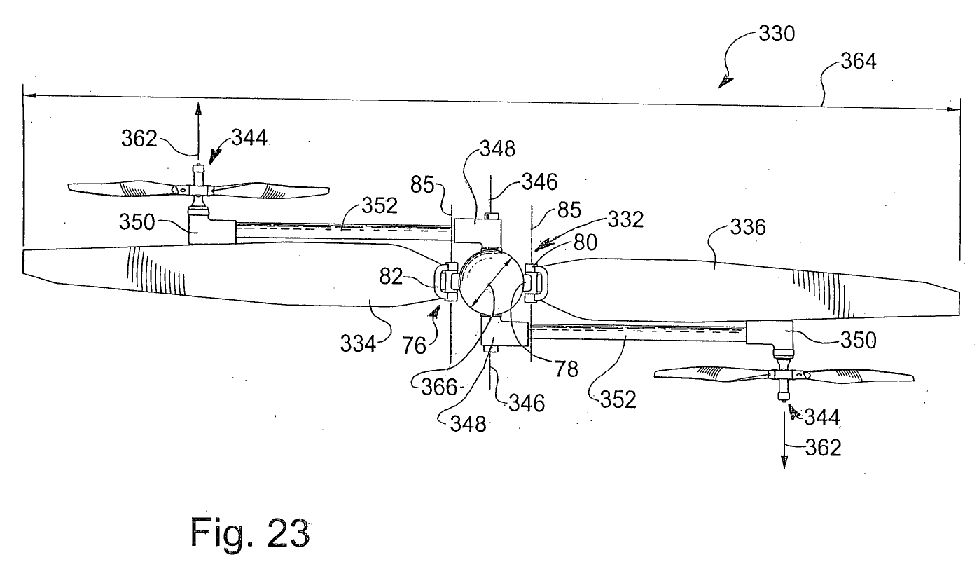

As shown in FIG. 22, a drive shaft 354 within each rotatable gearbox 348 extends generally perpendicularly from power module 86 and drives a bevel gear 356. Bevel gear 356 drives a second bevel gear 358 which is connected to drive shaft 360 inside boom 352. Drive shaft 352 is connected to rotor system 334 which produces a variable thrust force in direction 362 (shown in FIG. 21) to counter the torque generated by rotor system 332 and to control rotation of unit 330 about generally vertical body axis 60. As shown in FIG. 23, an illustrative rotor span 364 is 29 inches (73.66 cm), and a diameter 366 of body 52 is 2 inches (5.08 cm). Thus, unit 330 is miniature in size as well.

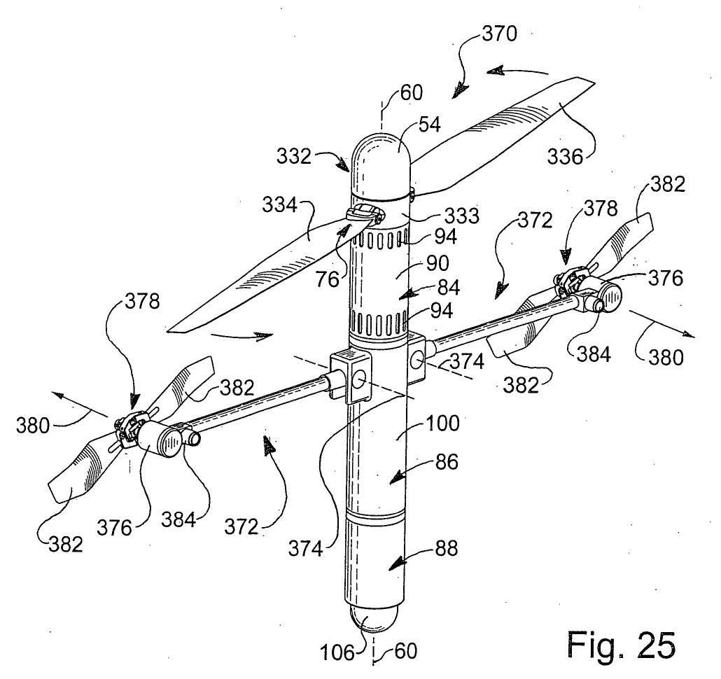

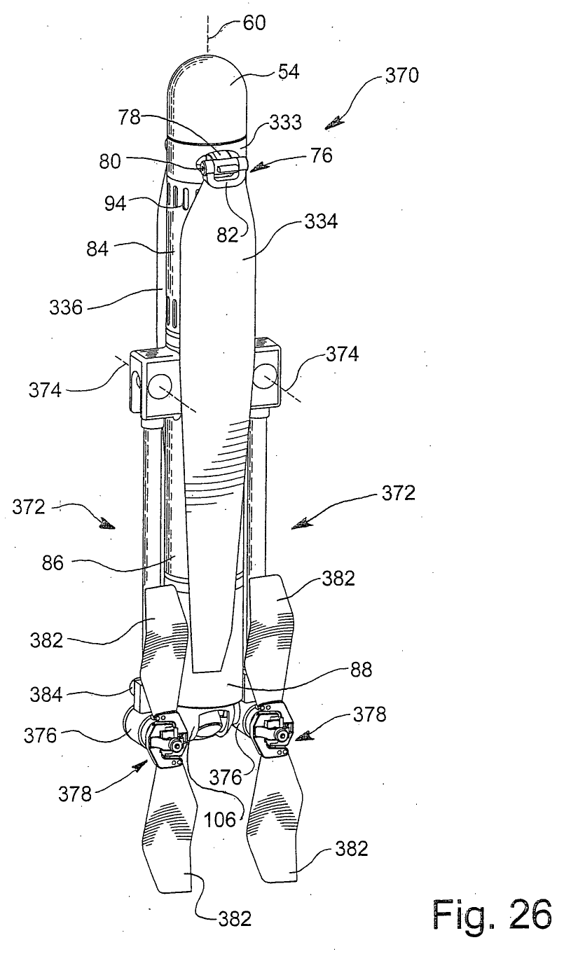

Looking now to FIGS. 25 and 26, yet another micro-rotorcraft unit 370 is provided for use with system 10. Unit 370 includes outrigger arms 372 each pivotable about a folding axis 374. Outrigger arms 372 are similar to arms 342 of unit 330 with the exception that outrigger arms 372 are each equipped with a variable speed electric motor 376 driving fixed-pitch rotors 378 have blades 382. In stable hovering flight, each rotor 372 develops a thrust force in direction 380 to counter the torque produced by blades 334,336. While outrigger arms 372 are generally shown extending from a middle portion of body 52, it is within the scope of the current disclosure to connect each outrigger arm 372 anywhere on body 52 and particularly at the lower end of body 52 so outrigger arms 372 can also act as landing legs.

One feature of variable speed electric motors 376 is that no complex gears or drive shafts are required to drive each rotor system 378. Fixed-pitch rotors 378 can be simpler and lighter than collective-pitch rotors (such as rotors 344 of unit 330). Each outrigger arm 372 is also fitted with a video camera 384 providing a human operator (not shown) with stereo vision and/or range-sensing capabilities.

As used herein, rotor blades, landing legs, aerodynamic fins, sensor arms, and yaw control outriggers are all known and referred to as “extendable-retractable elements” and generally share a common trait of being foldable or retractable alongside the respective elongated body portion of each unit.

The small or miniature size of each of units 18, 20, 22, 24, 310, 330, 370 allows a remote operator to silently look into windows, see over hills, observe from great heights and operate over any terrain or obstacle. Multiple units can be fused into the integrated data network 26 to cooperate with each other for large scale missions, for example. System 10, with units 18,20, 22, 24, 310, 330,317 disclosed herein, is provided to extend situational awareness of tactical forces, and to enhance the ability of the forces to accurately deliver sensors and ordnance. As mentioned above, each miniature unit is provided with interchangeable body modules for quickly adapting each unit to various configurations for any number of tasks, as a particular situation may require. System 10 provides a means and methods for deploying, recovering, and storing the micro-rotorcraft units disclosed herein.

The telemetry system of each unit 18, 20, 22, 24, 310, 330, 370 transmits sensor information to remote operators either in the field or within mobile command center 12. Each unit 18, 20, 22, 24, 310, 330, 370 may be ideal for long-term perimeter surveillance and networked systems. Although the units disclosed herein are small or miniature in size, multiple units 18,20, 22, 24, 310, 330, 370 working together may collect data to allow a remote operator to observe wide geographic areas from great heights and for extended time periods.

Units 18, 20, 22,24, 310, 330, 370 may be programmed to operate individually, or in multiples to create a coordinated group of units 18,20,22, 24, 310, 330, 370. In addition to military uses, other applications of system 10 with units 18, 20, 22,24, 310, 330, 370 include law enforcement such as for search-and-rescue missions, drug interdiction, surveillance, sampling of emissions and pollutants and other special situations, for example. System 10 also has applications in scientific research such as for atmospheric sampling and remote inspection, and within business such as for construction oversight, surveying, inspection of difficult to reach or hazardous areas and aerial photography, for example.

The various units 18, 20, 22, 24, 310, 330, 370 described above may be provided in a hand-held, miniature, flying micro-rotorcraft unit kit. In other words, one or more of the component parts, or any combination thereof, may be provided within a kit for assembly at a micro-rotorcraft assembly site, for example. Each kit may therefore be assembled to provide a miniature flying surveillance machine (or rotorcraft unit) operable by remote control.

In one illustrative embodiment, the kit includes hand-held payload module 88 including means (such as video camera 105, biological and/or chemical sensors, and/or an infra-red camera, for example) for conducting surveillance activities during flight. The kit also includes a hand-held lift generator module, such as rotor system 50, or other rotor systems described above. The lift generator module includes first hub 56 supported for rotation about vertical axis 60 in first direction 69 to rotate the first pair of rotor blades 68, 70 coupled to the first hub 56, and second hub 58 supported for rotation about vertical axis 60 in second direction 71 to rotate the second pair of rotor blades 72, 74 coupled to second hub 58.

The kit further includes a hand-held power module, such as modules 86 or 182, for example, containing a supply of energy, and a hand-held drive module, such as modules 84, 180, for example, including means for rotating the first and second hubs 56, 58 in opposite directions about vertical axis 60 to turn rotor blades 68, 70, 72, 74 to generate a thrust force that acts in a direction parallel to the vertical axis 60 using energy stored in the hand-held power module 86, 182. The kit also includes a quick-disconnect module coupling, such as coupling 96. The quick-disconnect module coupling of the kit is adapted to be installed at a junction between each pair of adjacent modules to retain each pair of adjacent modules in fixed relation to one another to unite the modules in series to cause the thrust force generated by the hand-held lift generator module to lift the united payload, power, and drive modules into the air to initiate flight.

The kit may also include one or more of the following: a hand-held navigation module, such as module 54, comprising means for determining a global position of the hand-held elongated body 50 during flight, a landing gear system, such as system 184, and anti-torque mechanisms such as aerodynamic fins 312 and/or yaw control outriggers 342, 372 for stabilizing the micro-rotorcraft unit in the yaw direction. Additionally, it is within the scope of this disclosure for the micro-rotorcraft unit kit to include any one or more components and combinations thereof described above with respect to units 18, 20, 22, 24, 310, 330, 370.

Although this invention has been described in detail with reference to certain embodiments, variations and modifications exist within the scope and spirit of the invention as described and defined in the following claims.

1. A hand-held, miniature flying micro-rotorcraft unit comprising
a plurality of interchangeable, modular components coupled to one another to form a hand-held elongated body defining a vertical axis, and
rotor means coupled to an upper end of the hand-held elongated body for rotation about the vertical axis to lift the hand-held elongated body into the air, the rotor means being driven by drive means located within one of the interchangeable modular components of the hand-held elongated body.

2. The unit of claim 1, wherein the hand-held elongated body is generally cylindrical in shape and each modular component is also generally cylindrical in shape.

3. The unit of claim 1, wherein each modular component includes a first module coupler at a first end of the component, and a second module coupler at a second end of the component, and wherein the first module coupler of one of the modular components is adapted to be coupled to the second module coupler of another of the modular components.

4. The unit of claim 3, wherein the first module coupler includes a first toothed ring positioned to lie about the vertical axis and having outwardly extending teeth, and wherein the second module coupler includes a second toothed ring positioned to lie about the vertical axis and having inwardly extending teeth defining detents therebetween, the detents being adapted to receive the outwardly extending teeth of the first toothed ring.

5. The unit of claim 4, wherein each of the outwardly extending teeth of the first toothed ring include an outer end having an angled cam surface.

6. The unit of claim 1, wherein the plurality of modular components includes a navigation module comprising means for determining a global position of the hand-held elongated body during flight of the micro-rotorcraft unit, a rotor hub assembly of the rotor means, a drive module including the drive means, a power module including means for energizing the drive means, and a payload module comprising at least one of munitions, a biological sensor, a chemical sensor, a video camera, and an infrared camera.

7. The unit of claim 6, wherein the rotor hub assembly is coupled to and positioned between the navigation module and the drive module, and wherein the power module is coupled to the drive module, and the payload module is coupled to the power module so that the navigation module and the payload module are positioned to lie at opposite ends of the hand-held elongated body.

8. The unit of claim 6, wherein the payload module further includes autonomous autopilot means for controlling the directional stability, including yaw, pitch, and roll, of the of the hand-held, miniature, flying micro-rotorcraft unit during flight.

9. The unit of claim 1, wherein the rotor means includes a first hub, a plurality of rotor blades coupled to the hub, means for supporting the first hub for rotation about the vertical axis, and hinge means for coupling each rotor blade to the hub so that each rotor blade is movable between an extended position generally perpendicular to the vertical axis and a retracted position generally parallel to the vertical axis.

10. The unit of claim 9, wherein the hinge means includes spring means for normally biasing each rotor blade to the extended position.

11. The unit of claim 10, further including latch means coupled to the hand-held elongated body for maintaining each rotor blade in the retracted position against the bias of the spring means.

12. The unit of claim 1, further including landing means coupled to the hand-held elongated body for supporting the hand-held elongated body prior to flight and upon landing.

13. The unit of claim 12, wherein the landing means includes a plurality of landing legs each being pivotably coupled to the hand-held elongated body for movement between a landing position to support the hand-held elongated body in a generally upright position and a stowed position wherein each landing leg is generally parallel to the vertical axis of the hand-held elongated body.

14. The unit of claim 1, further including anti-torque means coupled to the hand-held elongated body for countering a torque generated by the rotor means to control rotation of the unit about the vertical axis.

15. The unit of claim 14, wherein the anti-torque means includes a first and second yaw control outrigger each including a boom having a first end coupled to the body and being positioned to lie generally perpendicular to the vertical axis, and rotor means coupled to a second end of the boom for rotation about an axis generally perpendicular to the boom and the vertical axis.

16. The unit of claim 14, wherein the anti-torque means includes a plurality of fins coupled to the band-held elongated body and positioned to extend away from the hand-held elongated body in a direction generally perpendicular to the vertical axis.

17. The unit of claim 1, further comprising telemetry uplink and downlink systems located within the hand-held elongated body and configured to receive information from a command center and configured to send information to the command center.

18. A hand-held, miniature, flying micro-rotorcraft unit comprising
a hand-held elongated body having an upper end and a lower end and defining a vertical axis,
a navigation module comprising means for determining a global position of the elongated body during flight of the micro-rotorcraft unit, and
rotor means coupled to the upper end of the hand-held elongated body and located between the hand-held elongated body and the navigation module for generating a thrust force that acts in a direction parallel to the vertical axis to lift the hand-held elongated body into the air.

19. The unit of claim 18, wherein the rotor means includes a pair of upper rotor blades coupled to a first rotatable hub, a pair of lower rotor blades coupled to a second rotatable hub, and means for supporting the first and second rotatable hubs for rotation about the vertical axis in opposite directions.

20. The unit of claim 19, wherein the second rotatable hub is positioned to lie between the hand-held elongated body and first rotatable hub and the navigation module is coupled to the first rotatable hub.

21. The unit of claim 19, wherein the rotor means further includes first means for rotating the first hub in a first rotational direction and for collectively and cyclically pitching the upper rotor blades as the upper rotor blades rotate in the first rotational direction and second means for rotating the second hub in an opposite second rotational direction and for collectively and cyclically pitching the lower rotor blades as the lower rotor blades rotate in the second rotational direction.

22. The unit of claim 19, wherein the rotor means further includes hinge means for coupling each of the upper rotor blades to the first rotatble hub and each of the lower rotor blades to the second rotatble hub so that each rotor blade is movable between an extended position generally perpendicular to the vertical axis and retracted position generally parallel to the vertical axis to permit the rotor blades to pivot so as to the steer micro-rotorcraft unit in flight in various directions to maneuver around various obstacles and over certain terrain.

23. The unit of claim 19, wherein the rotor means further includes hinge means for coupling each of the upper rotor blades to the first rotatable hub and each of the lower rotor blades to the second rotatable hub so that each rotor blade is movable between an extended position generally perpendicular to the vertical axis and a retracted position generally parallel to the vertical axis to permit the rotor blades to pivot so as to steer the micro-rotorcraft unit in flight in various directions to maneuver around various obstacles and over certain terrain.

24. The unit of claim 19, wherein the hand-held elongated body comprises a drive module comprising motor means for driving the rotor means to develop sufficient thrust to lift the hand-held elongated body into the air and to cause the upper and lower rotor blades to generate cyclic thrust forces to tilt the rotor means relative to the horizontal to cause the micro-rotorcraft unit to fly in a generally upwardly and horizontal flight direction.

25. The unit of claim 23, wherein the hand-held elongated body further includes a payload module comprising at least one of explosive or incendiary munitions and biological and chemical sensors.

26. The unit of claim 23, wherein the hand-held elongated body further includes a power module located between the payload module and the drive module and the power module provides means for energizing the motor means.

27. The unit of claim 19, wherein the rotor means further includes a planetary gear system located in each of the first and second rotatable hubs and each planetary gear system is configured to rotate the rotatable hub associated therewith about the vertical axis.

28. The unit of claim 27, wherein the hand-held elongated body comprises a drive module comprising motor means for operating the planetary gear systems to rotate the hubs and the upper and lower rotor blades about the vertical axis to develop sufficient thrust to lift the hand-held elongated body into the air.

29. The unit of claim 28, wherein the drive module and the rotor means cooperate to define means for forming a quick-disconnect module coupling between the drive module and rotor means.

30. A hand-held, miniature, flying micro-rotorcraft unit kit having component parts capable of being assembled at a micro-rotorcraft assembly site to provide a miniature flying surveillance machine operable by remote control, the kit comprising the combination of
a hand-held payload module including means for conducting surveillance activities during flight,
a hand-held lift generator module comprising a first hub supported for rotation about a vertical axis in a first direction to rotate a first pair of rotor blades coupled to the first hub, and a second hub supported for rotation about the vertical axis in a second direction to rotate a second pair of rotor blades coupled to the second hub,
a hand-held power module containing a supply of energy,
a hand-held drive module including means for rotating the first and second hubs in opposite directions about the vertical axis to turn the rotor blades to generate a thrust force that acts in a direction parallel to the vertical axis using energy stored in the hand-held power module, and
a quick-disconnect module coupling adapted to be installed at a junction between each pair of adjacent modules to retain each pair of adjacent modules in fixed relation to one another to unite the modules in series to cause the thrust force generated by the hand-held lift generator module to lift the united payload, power, and drive modules into the air to initiate flight.

31. The kit of claim 30, wherein the hand-held drive, power, and payload modules are united in series using quick-disconnect module couplings to produce a hand-held elongated body having an upper end and a lower end and the hand-held lift generator module is coupled to the upper end of the hand-held elongated body.

32. The kit of claim 31, wherein the hand-held elongated body is about 20 inches in length and about two inches in width.

33. The kit of claim 31, further comprising a hand-held navigation module comprising means for determining a global position of the hand-held elongated body during flight and wherein the hand-held navigation module is adapted to be coupled to the hand-held lift generator module using the quick-disconnect module coupling to position the hand-held lift generator module between the hand-held elongated body and the hand-held navigation module.

34. A co-axial rotorcraft capable of sustained horizontal flight comprising
an elongated body having an elongated body axis,
a first rotor blade connected to the elongated body and rotatable in a first rotation direction about a first rotor axis substantially parallel to the body axis,
a second rotor blade connected to the elongated body and rotatable in a second rotation direction about a second rotor axis substantially parallel to the body axis, the second rotation direction being opposite of the first rotation direction, and
the elongated body is supported in flight by the first and second rotor blades with the body axis in a generally vertical orientation.

35. The rotorcraft of claim 34 further having a body aspect ratio being greater than 2:1.

36. The rotorcraft of claim 34 wherein the first rotor blade has a first root portion adjacent to the elongated body, a first tip portion spaced apart from the first root portion, a first blade axis extending between the first root portion and the first end portion, and the first rotor blade is foldable toward the body axis about a first folding axis perpendicular to the body axis to position the first blades axis in parallel relation to the body axis.

37. The rotorcraft of claim 34 wherein the elongated body further includes a first body module and a second body module, and the first and second body modules are connected with a quick-change module coupling.
